(19) United States
(12) Patent Application Publication
(10) Pub. No.: US 2024/0210542 A1
(43) Pub. Date: Jun. 27, 2024

(54) METHODS AND APPARATUS FOR LIDAR ALIGNMENT AND CALIBRATION

(71) Applicant: Boston Dynamics, Inc., Waltham, MA (US)

(72) Inventors: Matthew Turpin, Newton, MA (US); Andrew Hoelscher, Somerville, MA (US); Eyassu Shimelis, Cambridge, MA (US); Michael Murphy, Carlisle, MA (US); Mark Nehrkorn, Oregon, IL (US); Federico Vicentini, Lexington, MA (US); Neil Neville, Waltham, MA (US)

(73) Assignee: Boston Dynamics, Inc., Waltham, MA (US)

(21) Appl. No.: 18/545,124

(22) Filed: Dec. 19, 2023

Related U.S. Application Data
(60) Provisional application No. 63/434,504, filed on Dec. 22, 2022.
(60) Provisional application No. 63/509,616, filed on Jun. 22, 2023.

(51) Int. Cl. G01S 7/497; G01S 17/931

(52) U.S. Cl. CPC G01S 7/4972; G01S 17/931

(57) ABSTRACT

Methods and apparatus for automated calibration for a LIDAR system of a mobile robot are provided. The method comprises capturing a plurality of LIDAR measurements. The plurality of LIDAR measurements include a first set of LIDAR measurements as the mobile robot spins in a first direction at a first location, the first location being a first distance to a calibration target, and a second set of LIDAR measurements as the mobile robot spins in a second direction at a second location, the second location being a second distance to the calibration target, wherein the first direction and the second direction are different and the second distance is different than the first distance. The method further comprises processing the plurality of LIDAR measurements to determine calibration data, and generating alignment instructions for the LIDAR system based, at least in part, on the calibration data.

### CROSS-REFERENCE TO RELATED APPLICATIONS

This application claims the benefit under 35 U.S.C. § 119(e) to U.S. Provisional Patent Application No. 63/434,504, filed Dec. 22, 2022, and titled, “METHODS AND APPARATUS FOR LIDAR ALIGNMENT AND CALIBRATION,” and U.S. Provisional Patent Application No. 63/509,616, filed Jun. 22, 2023, and titled “METHODS AND APPARATUS FOR LIDAR ALIGNMENT AND CALIBRATION,” the entire contents of each of which is incorporated by reference herein.

### FIELD OF THE INVENTION

This disclosure relates to techniques for LIDAR alignment and calibration for a robotic device.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

Some mobile robots include light detection and ranging (LIDAR) systems that assist the robot with navigation and situational awareness in an environment within which it is operating. The LIDAR system may include one or more LIDAR units that transmit laser light and detect light reflected from objects in the environment, which is used to generate a distance map of objects in the robot's environment.

### SUMMARY

Mobile robots that include LIDAR systems may arrange individual LIDAR units around a base of the robot in a plane to provide essentially a 360 degree view of the environment surrounding the robot. Physically mounting planar LIDAR units rigidly to a robot may result in misalignment of the LIDAR plane of rotation with the floor on which the robot is placed. In this instance, if one or more of the LIDAR units is pointed down, the floor is detected as an object in the LIDAR measurements, and may be improperly interpreted as an obstacle, thereby hindering operation of the robot. Misalignment of LIDAR units can also result in mismatches in returns from different LIDAR units with respect to non-vertical surfaces in the environment, which may prevent accurate localization of the robot. For instance, attempting to match features from misaligned LIDAR units in 2D space may result in a detected object being represented in two very different places in the robot's environment, thereby hindering localization of the robot within its environment. Some embodiments of the technology described herein relate to automated techniques for calibration and alignment of LIDAR units that utilizes mobility of the robot to gather data to estimate the LIDAR orientation relative to the mobile base to which it is affixed.

In one aspect, the invention features a method of automated calibration for a LIDAR system of a mobile robot. The method includes capturing a plurality of LIDAR measurements. The plurality of LIDAR measurements includes a first set of LIDAR measurements as the mobile robot spins in a first direction at a first location, the first location being a first distance to a calibration target, and a second set of LIDAR measurements as the mobile robot spins in a second direction at a second location, the second location being a second distance to the calibration target, wherein the first direction and the second direction are different and the second distance is different than the first distance. The method further includes processing the plurality of LIDAR measurements to determine calibration data, and generating alignment instructions for the LIDAR system based, at least in part, on the calibration data.

In some embodiments, the method further includes detecting, by the LIDAR system, facets of the calibration target in an environment of the mobile robot. In some embodiments, the method further includes receiving information describing one or more characteristics of the calibration target, and detecting the facets of the calibration target is based, at least in part, on the received information. In some embodiments, detecting the facets of the calibration target comprises generating, based on information received from the LIDAR system, a first set of clusters, filtering the first set of clusters based, at least in part, on the received information, and detecting the facets of the calibration target based, at least in part, on the filtered first set of clusters. In some embodiments, detecting the facets of the calibration target further comprises determining, for each of the clusters in the filtered first set of clusters, a centroid, generating, using the centroids, a second set of clusters, filtering the second set of clusters based on one or more filtering criteria, and detecting the facets of the calibration target based, at least in part, on the filtered second set of clusters.

In some embodiments, the calibration target includes a plurality of facets, and processing the plurality of LIDAR measurements comprises detecting positions of edges of each of the plurality of facets of the calibration target. In some embodiments, each of the plurality of facets is a triangle. In some embodiments, the plurality of facets includes at least two triangles arranged in different orientations. In some embodiments, the plurality of facets includes three triangles. In some embodiments, each of the plurality of facets is an isosceles triangle. In some embodiments, detecting positions of edges of each of the plurality of facets of the calibration target comprises fitting a line to a plurality of points included in the plurality of LIDAR measurements, projecting radially to the line, at least some points included in the plurality of LIDAR measurements and not falling on the line, and detecting positions of the edges of each of the plurality of facets of the calibration target based, at least in part, on the projected points along the line.

In some embodiments, the mobile robot includes a base, the LIDAR system includes at least two LIDAR units arranged with overlapping fields-of-view in a same plane on the base of the mobile robot, and each of the first set of LIDAR measurements and the second set of LIDAR measurements includes LIDAR measurements from each of the at least two LIDAR units. In some embodiments, the base has four sides, the LIDAR system includes a LIDAR unit arranged in a same plane on each of the four sides of the base, and each of the first set of LIDAR measurements and the second set of LIDAR measurements includes LIDAR measurements from each of the LIDAR units in the LIDAR system. In some embodiments, processing the first set of LIDAR measurements and the second set of LIDAR measurements to determine calibration data comprises using pairs of LIDAR measurements from different LIDAR units to disambiguate one or more of pitch, roll and yaw of the LIDAR units.

In some embodiments, the LIDAR system includes a plurality of LIDAR units arranged at different locations on the mobile robot, and generating alignment instructions for the LIDAR system comprises displaying on a user interface an indication of which of the plurality of LIDAR units requires adjustment, and an amount of adjustment required to align a respective LIDAR unit. In some embodiments, an alignment of each of the plurality of LIDAR units is configured to be adjusted using a first adjustment mechanism and/or a second adjustment mechanism, and the amount of adjustment required to align the respective LIDAR unit comprises whether to adjust the first adjustment mechanism and/or the second adjustment mechanism and by how much. In some embodiments, each of the first adjustment mechanism and the second adjustment mechanism comprises a screw, and generating the alignment instructions for the LIDAR system comprises displaying on the user interface, an indication of how much to rotate one or both of the screws.

In some embodiments, the method further comprises determining whether the calibration data is within an acceptable threshold, and generating alignment instructions for the LIDAR system is only performed when it is determined that the calibration data is not within the acceptable threshold.

In some embodiments, the method further comprises receiving an indication that the LIDAR system has been aligned in accordance with the alignment instructions, capturing by the LIDAR system, a third set of LIDAR measurements, and validating that the LIDAR system is properly aligned based, at least in part, on the third set of LIDAR measurements.

In some embodiments, wherein processing the plurality of LIDAR measurements to determine calibration data comprises simultaneously estimating roll, pitch and yaw of each of the LIDAR units in the LIDAR system.

In some embodiments, capturing a plurality of LIDAR measurements comprises capturing the plurality of LIDAR measurements using a plurality of direct time-of-flight sensors arranged on a base of the mobile robot in a same plane.

In one aspect, the invention features a mobile robot. The mobile robot includes a LIDAR system including a plurality of LIDAR units arranged in a same plane, at least two of the LIDAR units having overlapping fields-of-view, a drive system configured to drive the mobile robot, and at least one hardware processor. The at least one hardware processor is configured to control the mobile robot to capture a plurality of LIDAR measurements by controlling the LIDAR system to capture a first set of LIDAR measurements as the mobile robot spins in a first direction at a first location, the first location being a first distance to a calibration target, controlling the drive system to drive the mobile robot to a second location being a second distance to the calibration target, wherein the second distance is different than the first distance, and controlling the LIDAR system to capture a second set of LIDAR measurements as the mobile robot spins in a second direction at the second location. The at least one hardware processor is further configured to process the plurality of LIDAR measurements to determine calibration data, and generate alignment instructions for the LIDAR system based, at least in part, on the calibration data.

In some embodiments, the mobile robot further includes a base, and the plurality of LIDAR units are arranged in the base. In some embodiments, the base has four sides, the LIDAR system includes a LIDAR unit arranged in the same plane on each of the four sides of the base, and each of the first set of LIDAR measurements and the second set of LIDAR measurements includes LIDAR measurements from each of the LIDAR units in the LIDAR system.

In some embodiments, the drive system is an omnidirectional drive system. In some embodiments, each of the plurality of LIDAR units comprises a direct time-of-flight sensor.

In some embodiments, the at least one hardware processor is further configured to process the plurality of LIDAR measurements to detect facets of the calibration target in an environment of the mobile robot. In some embodiments, the at least one hardware processor is further configured to receive information describing one or more characteristics of the calibration target, wherein processing the plurality of LIDAR measurements to detect the facets of the calibration target is based, at least in part, on the received information. In some embodiments, processing the plurality of LIDAR measurements to detect the facets of the calibration target comprises generating, based on the plurality of LIDAR measurements, a first set of clusters, filtering the first set of clusters based, at least in part, on the received information, and detecting the facets of the calibration target based, at least in part, on the filtered first set of clusters. In some embodiments, processing the plurality of LIDAR measurements to detect the facets of the calibration target further comprises determining, for each of the clusters in the filtered first set of clusters, a centroid, generating, using the centroids, a second set of clusters, filtering the second set of clusters based on one or more filtering criteria, and detecting the facets of the calibration target based, at least in part, on the filtered second set of clusters.

In some embodiments, the calibration target includes a plurality of facets, and processing the plurality of LIDAR measurements comprises detecting positions of edges of each of the plurality of facets of the calibration target. In some embodiments, each of the plurality of facets is a triangle. In some embodiments, the plurality of facets includes at least two triangles arranged in different orientations. In some embodiments, the plurality of facets includes three triangles. In some embodiments, each of the plurality of facets is an isosceles triangle. In some embodiments, detecting positions of edges of each of the plurality of facets of the calibration target comprises fitting a line to a plurality of points included in the plurality of LIDAR measurements, projecting radially to the line, at least some points included in the plurality of LIDAR measurements and not falling on the line, and detecting positions of the edges of each of the plurality of facets of the calibration target based, at least in part, on the projected points along the line.

In some embodiments, processing the plurality of LIDAR measurements to determine calibration data comprises using pairs of LIDAR measurements from different LIDAR units to disambiguate one or more of pitch, roll and yaw of the LIDAR units. In some embodiments, generating alignment instructions for the LIDAR system comprises displaying on a user interface, an indication of which of the plurality of LIDAR units requires adjustment, and an amount of adjustment required to align a respective LIDAR unit. In some embodiments, an alignment of each of the plurality of LIDAR units is configured to be adjusted using a first adjustment mechanism and/or a second adjustment mechanism, and the amount of adjustment required to align the respective LIDAR unit comprises whether to adjust the first adjustment mechanism and/or the second adjustment mechanism and by how much. In some embodiments, each of the first adjustment mechanism and the second adjustment mechanism comprises a screw, and generating the alignment instructions for the LIDAR system comprises displaying on the user interface, an indication of how much to rotate one or both of the screws.

In some embodiments, the at least one hardware processor is further configured to determine whether the calibration data is within an acceptable threshold, wherein generating alignment instructions for the LIDAR system is only performed when it is determined that the calibration data is not within the acceptable threshold.

In some embodiments, the at least one hardware processor is further configured to receive an indication that the LIDAR system has been aligned in accordance with the alignment instructions, capture by the LIDAR system, a third set of LIDAR measurements, and validate that the LIDAR system is properly aligned based, at least in part, on the third set of LIDAR measurements.

In some embodiments, processing the plurality of LIDAR measurements to determine calibration data comprises simultaneously estimating roll, pitch and yaw of each of the plurality of LIDAR units in the LIDAR system.

In one aspect, the invention features a controller for a mobile robot. The controller includes at least one hardware processor. The at least one hardware processor is configured to control the mobile robot to capture a plurality of LIDAR measurements by controlling a LIDAR system arranged on the mobile robot to capture a first set of LIDAR measurements as the mobile robot spins in a first direction at a first location, the first location being a first distance to a calibration target, controlling a drive system of the mobile robot to drive the mobile robot to second location being a second distance to the calibration target, wherein the second distance is different than the first distance, and controlling the LIDAR system to capture a second set of LIDAR measurements as the mobile robot spins in a second direction at the second location. The at least one hardware processor is further configured to process the plurality of LIDAR measurements to determine calibration data, and generate alignment instructions for the LIDAR system based, at least in part, on the calibration data.

In some embodiments, the at least one hardware processor is further configured to detect, by the LIDAR system, facets of the calibration target in an environment of the mobile robot. In some embodiments, the at least one hardware processor is further configured to receive information describing one or more characteristics of the calibration target, and detecting the facets of the calibration target is based, at least in part, on the received information. In some embodiments, detecting the facets of the calibration target comprises generating, based on information received from the LIDAR system, a first set of clusters, filtering the first set of clusters based, at least in part, on the received information, and detecting the facets of the calibration target based, at least in part, on the filtered first set of clusters. In some embodiments, detecting the facets of the calibration target further comprises determining, for each of the clusters in the filtered first set of clusters, a centroid, generating, using the centroids, a second set of clusters, filtering the second set of clusters based on one or more filtering criteria, and detecting the facets of the calibration target based, at least in part, on the filtered second set of clusters.

In some embodiments, the calibration target includes a plurality of facets, and processing the plurality of LIDAR measurements comprises detecting positions of edges of each of the plurality of facets of the calibration target. In some embodiments, each of the plurality of facets is a triangle. In some embodiments, the plurality of facets includes at least two triangles arranged in different orientations. In some embodiments, the plurality of facets includes three triangles. In some embodiments, each of the plurality of facets is an isosceles triangle. In some embodiments, detecting positions of edges of each of the plurality of facets of the calibration target comprises fitting a line to a plurality of points included in the plurality of LIDAR measurements, projecting radially to the line, at least some points included in the plurality of LIDAR measurements and not falling on the line, and detecting positions of the edges of each of the plurality of facets of the calibration target based, at least in part, on the projected points along the line.

In some embodiments, the mobile robot includes a base, the LIDAR system includes at least two LIDAR units arranged with overlapping fields-of-view in a same plane on the base of the mobile robot, and each of the first set of LIDAR measurements and the second set of LIDAR measurements includes LIDAR measurements from each of the at least two LIDAR units. In some embodiments, the base has four sides, the LIDAR system includes a LIDAR unit arranged in a same plane on each of the four sides of the base, and each of the first set of LIDAR measurements and the second set of LIDAR measurements includes LIDAR measurements from each of the LIDAR units in the LIDAR system. In some embodiments, processing the first set of LIDAR measurements and the second set of LIDAR measurements to determine calibration data comprises using pairs of LIDAR measurements from different LIDAR units to disambiguate one or more of pitch, roll and yaw of the LIDAR units.

In some embodiments, the LIDAR system includes a plurality of LIDAR units arranged at different locations on the mobile robot, and generating alignment instructions for the LIDAR system comprises displaying on a user interface, an indication of which of the plurality of LIDAR units requires adjustment, and an amount of adjustment required to align a respective LIDAR unit. In some embodiments, an alignment of each of the plurality of LIDAR units is configured to be adjusted using a first adjustment mechanism and/or a second adjustment mechanism, and the amount of adjustment required to align the respective LIDAR unit comprises whether to adjust the first adjustment mechanism and/or the second adjustment mechanism and by how much. In some embodiments, each of the first adjustment mechanism and the second adjustment mechanism comprises a screw, and generating the alignment instructions for the LIDAR system comprises displaying on the user interface, an indication of how much to rotate one or both of the screws.

In some embodiments, the at least one hardware processor is further configured to determine whether the calibration data is within an acceptable threshold, and generating alignment instructions for the LIDAR system is only performed when it is determined that the calibration data is not within the acceptable threshold.

In some embodiments, the at least one hardware processor is further configured to receive an indication that the LIDAR system has been aligned in accordance with the alignment instructions, capture by the LIDAR system, a third set of LIDAR measurements, and validate that the LIDAR system is properly aligned based, at least in part, on the third set of LIDAR measurements.

In some embodiments, processing the plurality of LIDAR measurements to determine calibration data comprises simultaneously estimating roll, pitch and yaw of each of the LIDAR units in the LIDAR system.

In some embodiments, capturing a plurality of LIDAR measurements comprises capturing the plurality of LIDAR measurements using a plurality of direct time-of-flight sensors arranged on a base of the mobile robot in a same plane.

In one aspect, the invention features a method of automated calibration for a LIDAR system of a mobile robot. The method includes capturing a plurality of LIDAR measurements including a first set of LIDAR measurements as the mobile robot spins in a first direction at a first location, the first location being a first distance to a calibration target, processing the plurality of LIDAR measurements to determine calibration data; and generating alignment instructions for the LIDAR system based, at least in part, on the calibration data.

In one aspect, the invention features a mobile robot. The mobile robot includes a LIDAR system including a plurality of LIDAR units arranged in a same plane, at least two of the LIDAR units having overlapping fields-of-view, and at least one hardware processor. The at least one hardware processor is configured to control the mobile robot to capture a plurality of LIDAR measurements by controlling the LIDAR system to capture a first set of LIDAR measurements as the mobile robot spins in a first direction at a first location, the first location being a first distance to a calibration target, process the plurality of LIDAR measurements to determine calibration data, and generate alignment instructions for the LIDAR system based, at least in part, on the calibration data.

In one aspect, the invention features a controller for a mobile robot. The controller includes at least one hardware processor configured to control the mobile robot to capture a plurality of LIDAR measurements by controlling a LIDAR system arranged on the mobile robot to capture a first set of LIDAR measurements as the mobile robot spins in a first direction at a first location, the first location being a first distance to a calibration target, process the plurality of LIDAR measurements to determine calibration data, and generate alignment instructions for the LIDAR system based, at least in part, on the calibration data.

In one aspect, the invention features a method of automated calibration of a mobile robot. The method includes selecting a first safety mode from among a plurality of safety modes, wherein the first safety mode includes a first set of limits describing safe operation of the mobile robot within the first safety mode, controlling the mobile robot to perform a first operation within the first safety mode, wherein the operation is a health check operation or a calibration operation, capturing first data during performance of the first operation, and updating one or more parameters associated with operation of the mobile robot based on the first data.

In some embodiments, the first set of limits includes at least one limit on motion of one or more components of the mobile robot. In some embodiments, the at least one limit on motion of one or more components of the mobile robot includes a limit on velocity or speed of a component of the mobile robot. In some embodiments, the one or more components of the mobile robot include a drive system of the mobile robot. In some embodiments, the one or more components of the mobile robot include a turntable of the mobile robot. In some embodiments, the one or more components of the mobile robot include an arm of the mobile robot. In some embodiments, the mobile robot includes at least one distance sensor mounted on a base of the mobile robot, and the first set of limits includes at least one limit associated with objects sensed by the at least one distance sensor.

In some embodiments, the mobile robot includes a drive system and a turntable, and the first set of limits includes limiting motion of the drive system and the turntable. In some embodiments, controlling the mobile robot to perform a first operation within the first safety mode comprises controlling an arm of the mobile robot to grasp and manipulate an object within a vertical plane. In some embodiments, the first set of limits includes at least one speed limit associated with movement of the arm of the mobile robot, and the method further includes monitoring, with at least one sensor of the mobile robot, a speed of movement of the arm of the mobile robot, determining that the first set of limits is violated when the monitored speed exceeds the at least one speed limit, and automatically stopping operation of the mobile robot when it is determined that the first set of limits is violated. In some embodiments, the method further includes determining a health of one or more components of the mobile robot during performance of the first operation, and updating one or more parameters associated with operation of the mobile robot comprises storing an indication of the determined health of the one or more components. In some embodiments, the method further includes controlling the mobile robot to perform a calibration operation in the first safety mode when it is determined that the health of the one or more components is poor. In some embodiments, controlling the mobile robot to perform a first operation within the first safety mode comprises performing a calibration operation. In some embodiments, performing a calibration operation includes controlling an end effector of the mobile robot to position a calibration target in a field of view of a perception system of the mobile robot, capturing first data during performance of the operation comprises capturing one or more images of the calibration target using the perception system, and updating one or more parameters associated with operation of the mobile robot comprises storing one or more calibration parameters for the perception system in a memory of the robot, the one or more calibration parameters being determined based, at least in part, on the one or more images.

In some embodiments, the mobile robot includes a turntable and an arm, and the first set of limits includes limiting motion of the turntable and the arm. In some embodiments, controlling the mobile robot to perform a first operation within the first safety mode comprises controlling a drive system of the mobile robot to drive the mobile robot according to a programmed sequence of movements. In some embodiments, capturing first data during performance of the first operation comprises capturing, using a LIDAR system onboard the mobile robot, LIDAR measurements as the mobile robot is controlled to drive according to the programmed sequence of movements, and updating one or more parameters associated with operation of the mobile robot comprises storing one or more calibration parameters for the LIDAR system of the mobile robot.

In some embodiments, the mobile robot includes a drive system and an arm, and the first set of limits includes limiting motion of the drive system and the arm. In some embodiments, controlling the mobile robot to perform a first operation within the first safety mode comprises controlling a turntable of the mobile robot to rotate at one or more speeds. In some embodiments, the method further includes determining a health of the turntable during performance of the first operation, and updating one or more parameters associated with operation of the mobile robot comprises storing an indication of the determined health of the turntable. In some embodiments, controlling the mobile robot to perform a first operation within the first safety mode further comprises stowing the arm of the mobile robot within a footprint of a base of the mobile robot prior to controlling the turntable of the mobile robot to rotate at the one or more speeds.

In some embodiments, the method further includes selecting a second safety mode from among the plurality of safety modes, wherein the second safety mode includes a second set of limits describing safe operation of the mobile robot within the second safety mode, controlling the mobile robot to perform a second operation within the second safety mode, wherein the operation is a health check operation or a calibration operation, capturing second data during performance of the second operation, and updating one or more parameters associated with operation of the mobile robot based on the second data.

In some embodiments, the method further includes performing self-safeguarding based on sensor data indicating information about a local environment of the mobile robot, and controlling the mobile robot to perform the first operation within the first safety mode comprises controlling the mobile robot to perform the first operation based at least in part, on the self-safeguarding. In some embodiments, the mobile robot includes a LIDAR system configured to sense the presence of objects in an area near the mobile robot, and the method further includes performing self-safeguarding comprises determining, based at least in part, on sensed data from the LIDAR system, whether the area near the mobile robot includes any objects, and controlling the mobile robot to perform the first operation within the first safety mode comprises controlling the mobile robot to perform the first operation when it is determined that the area near the mobile robot does not include any objects. In some embodiments, the method further includes automatically stopping performance of the first operation when an object is sensed by the LIDAR system in the area near the mobile robot. In some embodiments, the method further includes muting at least a portion of the area near the mobile robot within a field of view of the LIDAR system when determining whether the area near the mobile robot includes any objects. In some embodiments, the method further includes receiving at least some of the sensor data from one or more sensors onboard the mobile robot. In some embodiments, the method further includes receiving at least some of the sensor data from one or more sensors located external to the mobile robot.

In some embodiments, the first set of limits includes motion restrictions for at least one component of the mobile robot. In some embodiments, the method further includes sensing with at least one sensor, motion information associated with the at least one component of the mobile robot, determining that the sensed motion information violates at least one limit in the first set of limits, and automatically stopping performance of the first operation when it is determined that the sensed motion violates the at least one limit in the first set of limits.

In some embodiments, the method further includes adjusting one or more limits in the first set of limits based on received sensor data, the sensor data indicating information about a local environment of the mobile robot, and controlling the mobile robot to perform the first operation within the first safety mode comprises controlling the mobile robot to perform the first operation in accordance with the adjusted one or more limits. In some embodiments, the method further includes receiving at least some of the sensor data from one or more sensors onboard the mobile robot. In some embodiments, the one or more sensors onboard the mobile robot include a LIDAR system configured to sense the presence of objects in an area near the mobile robot. In some embodiments, the method further includes receiving at least some of the sensor data from one or more sensors located external to the mobile robot.

In one aspect, the invention features a mobile robot. The mobile robot includes at least one hardware processor configured to select a first safety mode from among a plurality of safety modes, wherein the first safety mode includes a first set of limits describing safe operation of the mobile robot within the first safety mode, control the mobile robot to perform a first operation within the first safety mode, wherein the operation is a health check operation or a calibration operation, capture first data during performance of the first operation, and update one or more parameters associated with operation of the mobile robot based on the first data.

In some embodiments, the mobile robot further includes one or more components configured to move in response to control instructions, and the first set of limits includes at least one limit on motion of the one or more components. In some embodiments, the at least one limit on motion of one or more components of the mobile robot includes a limit on velocity or speed of a component of the mobile robot. In some embodiments, the one or more components include a drive system. In some embodiments, the one or more components include a turntable. In some embodiments, the one or more components include an arm of the mobile robot. In some embodiments, the mobile robot further includes a base, and at least one distance sensor mounted on the base, and the first set of limits includes at least one limit associated with objects sensed by the at least one distance sensor.

In some embodiments, the mobile robot further includes a drive system, and a turntable, and the first set of limits includes limiting motion of the drive system and the turntable. In some embodiments, controlling the mobile robot to perform a first operation within the first safety mode comprises controlling an arm of the mobile robot to grasp and manipulate an object within a vertical plane. In some embodiments, the first set of limits includes at least one speed limit associated with movement of the arm of the mobile robot, and the at least one hardware processor is further configured to monitor, with at least one sensor of the mobile robot, a speed of movement of the arm of the mobile robot, determine that the first set of limits is violated when the monitored speed exceeds the at least one speed limit, and automatically stop operation of the mobile robot when it is determined that the first set of limits is violated. In some embodiments, the at least one hardware processor is further configured to determine a health of one or more components of the mobile robot during performance of the first operation, and updating one or more parameters associated with operation of the mobile robot comprises storing an indication of the determined health of the one or more components. In some embodiments, the at least one hardware processor is further configured to control the mobile robot to perform a calibration operation in the first safety mode when it is determined that the health of the one or more components is poor. In some embodiments, controlling the mobile robot to perform a first operation within the first safety mode comprises performing a calibration operation. In some embodiments, the mobile robot further includes an end effector, and a perception system, and performing a calibration operation includes controlling the end effector to position a calibration target in a field of view of the perception system, capturing first data during performance of the operation comprises capturing one or more images of the calibration target using the perception system, and updating one or more parameters associated with operation of the mobile robot comprises storing one or more calibration parameters for the perception system in a memory of the robot, the one or more calibration parameters being determined based, at least in part, on the one or more images.

In some embodiments, the mobile robot further includes a turntable, and an arm, and the first set of limits includes limiting motion of the turntable and the arm. In some embodiments, the mobile robot further includes a drive system, and controlling the mobile robot to perform a first operation within the first safety mode comprises controlling the drive system to drive the mobile robot according to a programmed sequence of movements. In some embodiments, the mobile robot further includes a LIDAR system, capturing first data during performance of the first operation comprises capturing, using the LIDAR system, LIDAR measurements as the mobile robot is controlled to drive according to the programmed sequence of movements, and updating one or more parameters associated with operation of the mobile robot comprises storing one or more calibration parameters for the LIDAR system.

In some embodiments, the mobile robot further includes a drive system, and an arm, and the first set of limits includes limiting motion of the drive system and the arm. In some embodiments, the mobile robot further includes a turntable, and controlling the mobile robot to perform a first operation within the first safety mode comprises controlling the turntable to rotate at one or more speeds. In some embodiments, the at least one hardware processor is further configured to determine a health of the turntable during performance of the first operation, and updating one or more parameters associated with operation of the mobile robot comprises storing an indication of the determined health of the turntable. In some embodiments, the mobile robot further includes a base, and controlling the mobile robot to perform a first operation within the first safety mode further comprises stowing the arm of the mobile robot within a footprint of the base prior to controlling the turntable to rotate at the one or more speeds.

In some embodiments, the at least one hardware processor is further configured to select a second safety mode from among the plurality of safety modes, wherein the second safety mode includes a second set of limits describing safe operation of the mobile robot within the second safety mode, control the mobile robot to perform a second operation within the second safety mode, wherein the operation is a health check operation or a calibration operation, capture second data during performance of the second operation, and update one or more parameters associated with operation of the mobile robot based on the second data.

In some embodiments, the at least one hardware processor is further configured to perform self-safeguarding based on sensor data indicating information about a local environment of the mobile robot, and controlling the mobile robot to perform the first operation within the first safety mode comprises controlling the mobile robot to perform the first operation based at least in part, on the self-safeguarding. In some embodiments, the mobile robot further includes a LIDAR system configured to sense the presence of objects in an area near the mobile robot, performing self-safeguarding comprises determining, based at least in part, on sensed data from the LIDAR system, whether the area near the mobile robot includes any objects, and controlling the mobile robot to perform the first operation within the first safety mode comprises controlling the mobile robot to perform the first operation when it is determined that the area near the mobile robot does not include any objects. In some embodiments, the at least one hardware processor is further configured to automatically stop performance of the first operation when an object is sensed by the LIDAR system in the area near the mobile robot. In some embodiments, the at least one hardware processor is further configured to mute at least a portion of the area near the mobile robot within a field of view of the LIDAR system when determining whether the area near the mobile robot includes any objects. In some embodiments, the mobile robot further includes one or more sensors onboard the mobile robot, and the at least one hardware processor is further configured to receive at least some of the sensor data from the one or more sensors onboard the mobile robot. In some embodiments, the at least one hardware processor is further configured to receive at least some of the sensor data from one or more sensors located external to the mobile robot.

In some embodiments, the first set of limits includes motion restrictions for at least one component of the mobile robot. In some embodiments, the mobile robot further includes at least one sensor, and the at least one hardware processor is further configured to sense with the at least one sensor, motion information associated with the at least one component of the mobile robot, determine that the sensed motion information violates at least one limit in the first set of limits, and automatically stop performance of the first operation when it is determined that the sensed motion violates the at least one limit in the first set of limits.

In some embodiments, the at least one hardware processor is further configured to adjust one or more limits in the first set of limits based on received sensor data, the sensor data indicating information about a local environment of the mobile robot, and controlling the mobile robot to perform the first operation within the first safety mode comprises controlling the mobile robot to perform the first operation in accordance with the adjusted one or more limits. In some embodiments, the mobile robot further includes one or more sensors onboard the mobile robot, and the at least one hardware processor is further configured to receive at least some of the sensor data from the one or more sensors onboard the mobile robot. In some embodiments, the one or more sensors onboard the mobile robot include a LIDAR system configured to sense the presence of objects in an area near the mobile robot. In some embodiments, the at least one hardware processor is further configured to receive at least some of the sensor data from one or more sensors located external to the mobile robot.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a perspective view of a robot, according to an illustrative embodiment of the invention.

FIG. 4 schematically illustrates a process for automated calibration and alignment of a LIDAR system for a mobile robot, according to an illustrative embodiment of the invention.

FIG. 5 is a schematic top down view of a sequence of movements of a mobile robot for gathering LIDAR measurements used to perform automated calibration and alignment of a LIDAR system for a mobile robot, according to an illustrative embodiment of the invention.

FIG. 6 is a flowchart of a process for automated calibration and alignment of a LIDAR system for a mobile robot, according to an illustrative embodiment of the invention.

FIG. 7 is a schematic illustration of a calibration target, according to an illustrative embodiment of the invention.

FIG. 8 is a schematic illustration of various LIDAR scans overlaid onto the calibration target shown in FIG. 7.

FIG. 9 schematically illustrates a process for estimating a pose of one or more LIDAR units coupled to a mobile robot, according to an illustrative embodiment of the invention.

FIG. 10 is a flowchart of a process for detecting a calibration target in an environment of a mobile robot, according to an illustrative embodiment of the invention.

FIG. 11 schematically illustrates a sequence of N detections of reflected LIDAR signals as a mobile robot spins, according to an illustrative embodiment of the invention.

FIG. 12 schematically illustrates a process for correcting for a mixed pixel effect when detecting facet edges of a calibration target, according to an illustrative embodiment of the invention.

FIG. 13 is a flowchart of a process for accurately extracting facet edges of a calibration target, according to an illustrative embodiment of the invention.

FIG. 14 schematically illustrates a process for estimating a pose of a LIDAR unit of a mobile robot, according to an illustrative embodiment of the invention.

FIG. 15 is a flowchart of a process for generating alignment instructions to inform a user how to align one or more misaligned LIDAR units of a mobile robot.

FIG. 16A schematically illustrates a mobile robot performing a health check operation in a particular safety mode, according to an illustrative embodiment of the invention.

FIG. 16B schematically illustrates a mobile robot performing a health check operation in a particular safety mode, according to an illustrative embodiment of the invention.

FIG. 16C schematically illustrates a mobile robot performing a calibration operation in a particular safety mode, according to an illustrative embodiment of the invention.

FIG. 17 schematically illustrates a loading dock environment in which a mobile robot may safely perform health check and/or calibration operations, according to an illustrative embodiment of the invention.

FIG. 18 illustrates an example configuration of a robotic device, according to an illustrative embodiment of the invention.

### DETAILED DESCRIPTION

Mobile robots may benefit from periodic calibration (e.g., after service is performed, after collision with an object, etc.), and it may be helpful for the mobile robot to occasionally evaluate its own status and/or health of various components (e.g., drive system, turntable, arms, gripper, etc.) of the robot. As described in more detail herein, a mobile robot configured in accordance with some embodiments may be preprogrammed with a plurality of behaviors to perform such self-calibrations and/or health checks without requiring an operator controlling the robot. The preprogrammed behaviors may require some amount of motion of the arm/manipulator and/or perception system of the robot, which may pose a risk to humans or other objects located near the robot if safety measures are not taken. Conventional approaches for ensuring safe operation of a robot include the use of cages and barriers to safeguard a space within which the robot is operating. For instance, for fixed-location robot arms, fixed physical or external sensor-based safeguarding is typical. The inventors have recognized and appreciated that for mobile robots, it may be beneficial to allow the robot to perform calibration and/or health check operations in any open space (e.g., not requiring a cage or fencing) in the robot's environment, such as a warehouse. Some embodiments of the present disclosure relate to implementing a plurality of safety modes on the robot, each of which defines a set of limits within which one or more operations (e.g., one or more calibration and/or health check behaviors) can be performed safely. A safety computer onboard the robot may compare sensed values from one or more sensors (e.g., on the robot and/or external to the robot) with the set of limits defined by a particular safety mode in which the robot is operating to ensure that the robot is operating within the limits, and automatically shut down operation of the robot when any of the limits associated with the safety mode is violated. Such self-safeguarding may enable, for example, on-demand auto recalibration during operation, and requalification after service without the need to occupy a dedicated safe workspace. Providing safe operation of calibration and/or health check behaviors in any open space of the robot's environment such as a warehouse may enable repairs/service to occur in more convenient locations in the warehouse without disrupting active work areas.

An example of a component of a mobile robot that may require periodic calibration includes the distance sensors (e.g., LIDAR units) included on the base of the robot. Alignment of LIDAR units rigidly coupled to a mobile robot is typically a manual procedure in which a human adjusts the LIDAR units until they are aligned well enough, potentially aided by a level or special-build device providing visual feedback. Such a process typically requires human training and expensive equipment, is not very accurate or repeatable, and takes a long time (e.g., at least one hour) due to the iterative nature of having to adjust and test the alignment several times until the user is satisfied that the alignment for all of the LIDAR units is suitable. These manual alignment procedures often lack a calibration step, where the final orientations of the LIDAR units are accurately measured, stored, and potentially used by the robotic system to compensate for alignment imprecision as the robotic system processes LIDAR sensor data. The inventors have recognized and appreciated that conventional techniques for calibrating and aligning co-planar LIDAR units on mobile robots can be improved by using the motion of the robot in combination with known information about the LIDAR units and a calibration target. To this end, some embodiments of the present disclosure relate to an automated process for calibrating and aligning LIDAR sensors mounted on a mobile robot. Such an approach reduces the amount of time needed to perform the calibration and alignment, and does not require a trained operator to perform the alignment, as discussed in more detail herein.

More generally, as described above, components of the mobile robot other than the LIDAR units may also benefit from occasional calibration and/or health checks. For instance, when the mobile robot is configured to grasp and move boxes using a suction-based gripper, the components of the robot that permit such operations, such as the arm/manipulator joints, the vacuum system, and the perception system, may be periodically checked to ensure that they are operating as expected. Additionally, following service (e.g., replacing a camera in a perception module), it may be desired to calibrate the serviced component prior to use. To facilitate these calibration and/or health check operations, some embodiments of the present disclosure relate to a self-safeguarding technique that uses safety fields associated with the LIDAR system in coordination with safety modes of operation that selectively limit the motion of the robot to ensure that the calibration and/or health check behaviors can be performed safely.

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

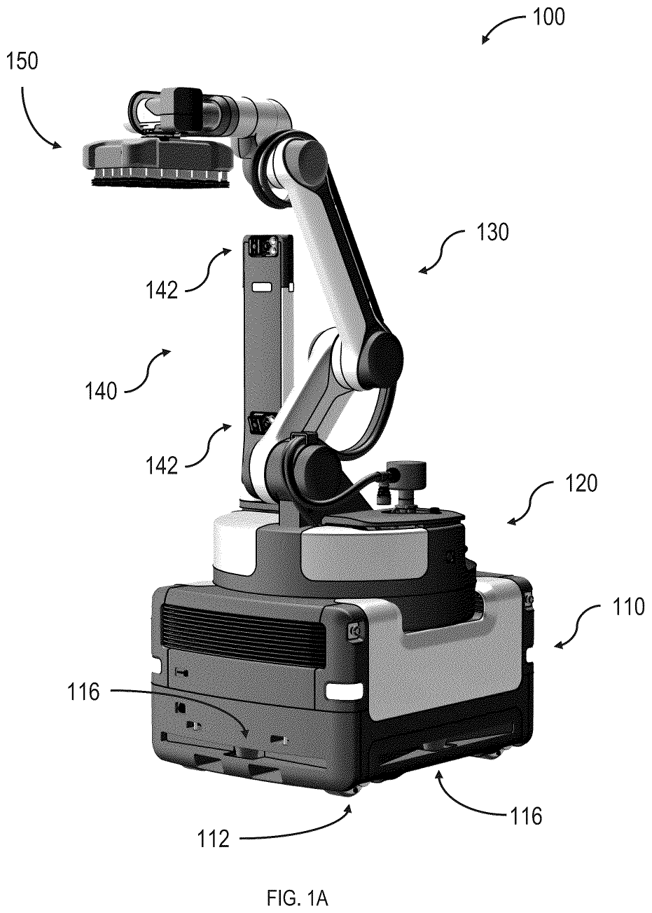

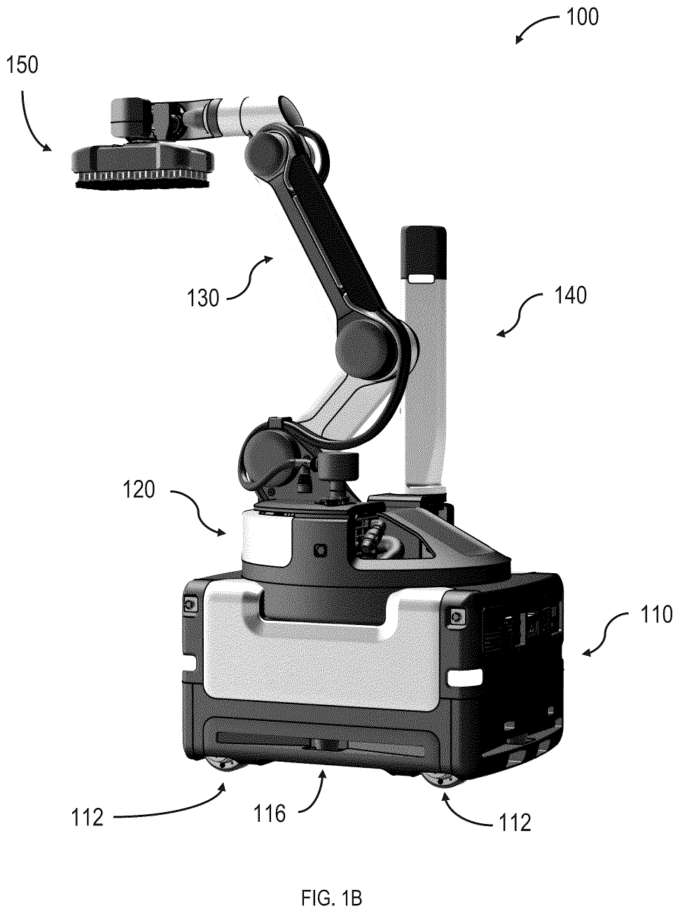

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

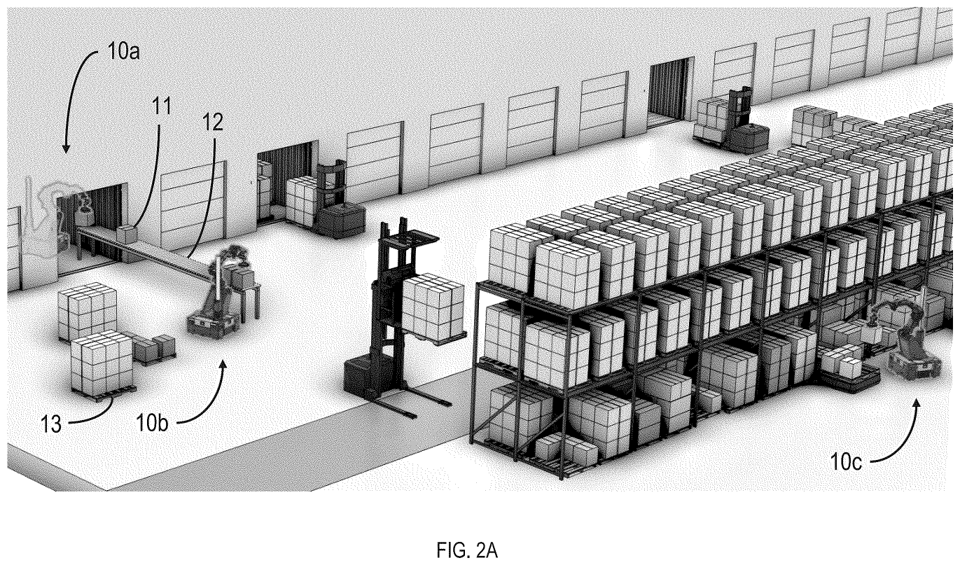

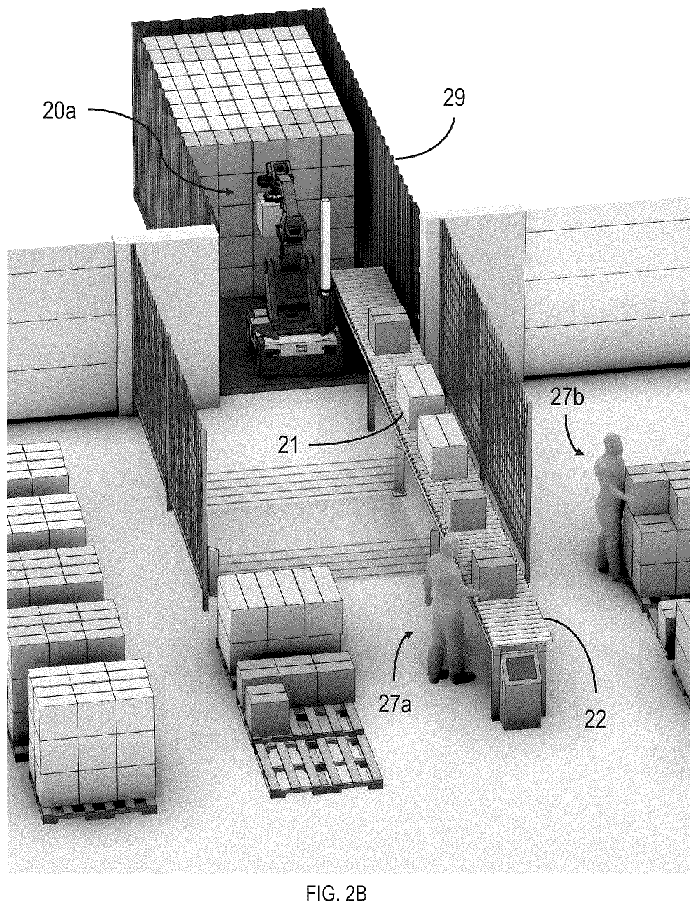

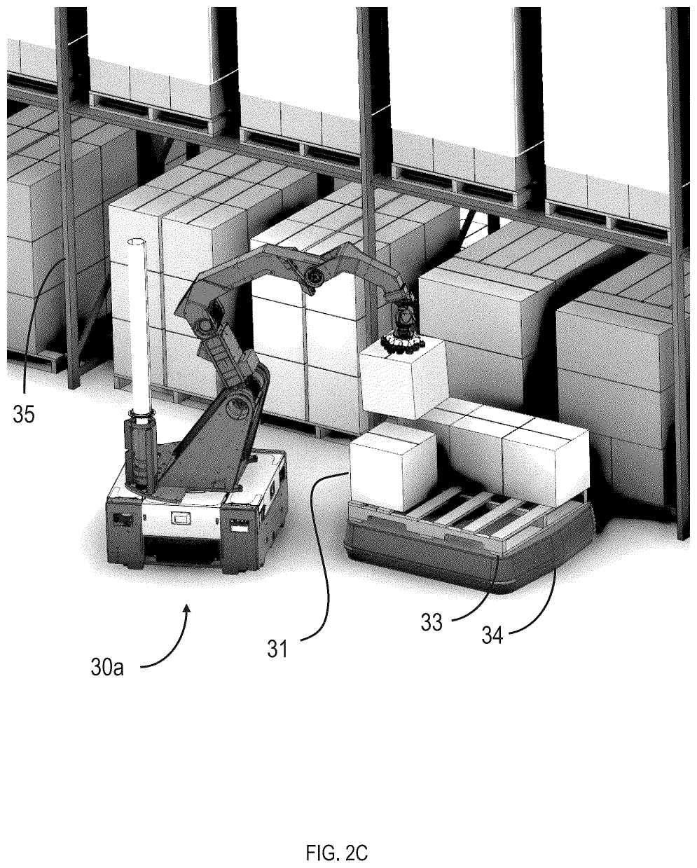

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

### Example Robotic Arm

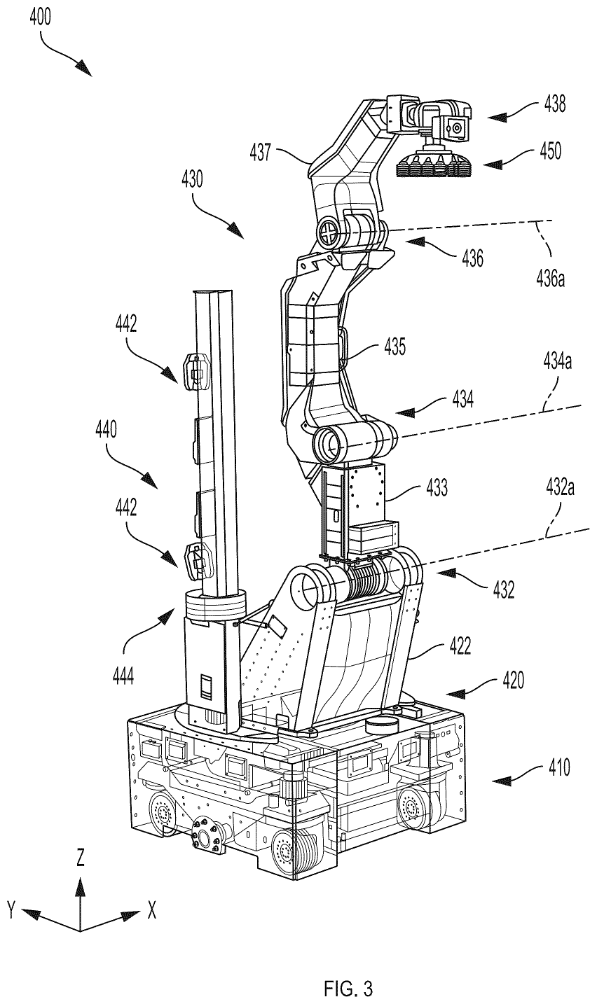

FIG. 3 is a perspective view of a robot 400, according to an illustrative embodiment of the invention. The robot 400 includes a mobile base 410 and a turntable 420 rotatably coupled to the mobile base. A robotic arm 430 is operatively coupled to the turntable 420, as is a perception mast 440. The perception mast 440 includes an actuator 444 configured to enable rotation of the perception mast 440 relative to the turntable 420 and/or the mobile base 410, so that a direction of the perception modules 442 of the perception mast may be independently controlled.

The robotic arm 430 of FIG. 3 is a 6-DOF robotic arm. When considered in conjunction with the turntable 420 (which is configured to yaw relative to the mobile base about a vertical axis parallel to the Z axis), the arm/turntable system may be considered a 7-DOF system. The 6-DOF robotic arm 430 includes three pitch joints 432, 434, and 436, and a 3-DOF wrist 438 which, in some embodiments, may be a spherical 3-DOF wrist.

Starting at the turntable 420, the robotic arm 430 includes a turntable offset 422, which is fixed relative to the turntable 420. A distal portion of the turntable offset 422 is rotatably coupled to a proximal portion of a first link 433 at a first joint 432. A distal portion of the first link 433 is rotatably coupled to a proximal portion of a second link 435 at a second joint 434. A distal portion of the second link 435 is rotatably coupled to a proximal portion of a third link 437 at a third joint 436. The first, second, and third joints 432, 434, and 436 are associated with first, second, and third axes 432a, 434a, and 436a, respectively.

The first, second, and third joints 432, 434, and 436 are additionally associated with first, second, and third actuators (not labeled) which are configured to rotate a link about an axis. Generally, the nth actuator is configured to rotate the nth link about the nth axis associated with the nth joint. Specifically, the first actuator is configured to rotate the first link 433 about the first axis 432a associated with the first joint 432, the second actuator is configured to rotate the second link 435 about the second axis 434a associated with the second joint 434, and the third actuator is configured to rotate the third link 437 about the third axis 436a associated with the third joint 436. In the embodiment shown in FIG. 3, the first, second, and third axes 432a, 434a, and 436a are parallel (and, in this case, are all parallel to the X axis). In the embodiment shown in FIG. 3, the first, second, and third joints 432, 434, and 436 are all pitch joints.

In some embodiments, a robotic arm of a highly integrated mobile manipulator robot may include a different number of degrees of freedom than the robotic arms discussed above. Additionally, a robotic arm need not be limited to a robotic arm with three pitch joints and a 3-DOF wrist. A robotic arm of a highly integrated mobile manipulator robot may include any suitable number of joints of any suitable type, whether revolute or prismatic. Revolute joints need not be oriented as pitch joints, but rather may be pitch, roll, yaw, or any other suitable type of joint.

Returning to FIG. 3, the robotic arm 430 includes a wrist 438. As noted above, the wrist 438 is a 3-DOF wrist, and in some embodiments may be a spherical 3-DOF wrist. The wrist 438 is coupled to a distal portion of the third link 437. The wrist 438 includes three actuators configured to rotate an end effector 450 coupled to a distal portion of the wrist 438 about three mutually perpendicular axes. Specifically, the wrist may include a first wrist actuator configured to rotate the end effector relative to a distal link of the arm (e.g., the third link 437) about a first wrist axis, a second wrist actuator configured to rotate the end effector relative to the distal link about a second wrist axis, and a third wrist actuator configured to rotate the end effector relative to the distal link about a third wrist axis. The first, second, and third wrist axes may be mutually perpendicular. In embodiments in which the wrist is a spherical wrist, the first, second, and third wrist axes may intersect.

In some embodiments, an end effector may be associated with one or more sensors. For example, a force/torque sensor may measure forces and/or torques (e.g., wrenches) applied to the end effector. Alternatively or additionally, a sensor may measure wrenches applied to a wrist of the robotic arm by the end effector (and, for example, an object grasped by the end effector) as the object is manipulated. Signals from these (or other) sensors may be used during mass estimation and/or path planning operations. In some embodiments, sensors associated with an end effector may include an integrated force/torque sensor, such as a 6-axis force/torque sensor. In some embodiments, separate sensors (e.g., separate force and torque sensors) may be employed. Some embodiments may include only force sensors (e.g., uniaxial force sensors, or multi-axis force sensors), and some embodiments may include only torque sensors. In some embodiments, an end effector may be associated with a custom sensing arrangement. For example, one or more sensors (e.g., one or more uniaxial sensors) may be arranged to enable sensing of forces and/or torques along multiple axes. An end effector (or another portion of the robotic arm) may additionally include any appropriate number or configuration of cameras, distance sensors, pressure sensors, light sensors, or any other suitable sensors, whether related to sensing characteristics of the payload or otherwise, as the disclosure is not limited in this regard.

As described above, to ensure that a mobile robot operating in a warehouse environment can continue to operate optimally and as expected, it may be beneficial to have the robot perform one or more preprogrammed health check and/or calibration behaviors. While such behaviors may be performed in any open space in the warehouse (e.g., in an empty loading dock area), adequate safety measures should be in place to prevent collision of components of the robot with humans or other objects near the robot during performance of the behaviors.

As described above, mobile robots often include distance sensors (e.g., distance sensors 116 illustrated in robot 100 of FIGS. 1A and 1B) that enable the robot to move safely about its environment. In some embodiments of the present disclosure, the distance sensors are co-planar LIDAR units arranged on multiple sides of the base of the mobile robot. Collectively, the LIDAR units may provide a 360° view around the base of the robot to detect obstructions and/or to facilitate localization of the robot in its environment. In the example robot shown in FIGS. 1A and 1B, mobile robot 100 has a distance measurement system that includes four co-planar distance sensors (e.g., LIDAR units) with overlapping fields-of-view, arranged a fixed distance (e.g., 15 cm) from the floor on which the robot is placed.

Some embodiments of the present disclosure use information from the LIDAR units to ensure that a sufficient amount of space around the robot is clear to perform an operation (e.g., a health check or a calibration operation). When sufficient space is not available, other safety measures can be used in a complimentary fashion. For example, human oversight, awareness barriers, and/or existing physical barriers such as a wall or loading dock door, may be used to ensure a safe operating space for the robot to perform the operation. To further ensure safety when performing a health check and/or calibration operation, the robot may be configured to operate in one of a plurality of safety modes, wherein each safety mode defines a set of operating limits for one or more components of the robot. For example, when performing a calibration of the arm of the robot, the speed/velocity of the arm joints may be monitored by a safety system onboard the robot not to exceed a limit. When any of the operating limits in a safety mode is violated, the robot may be configured to automatically shut itself down.

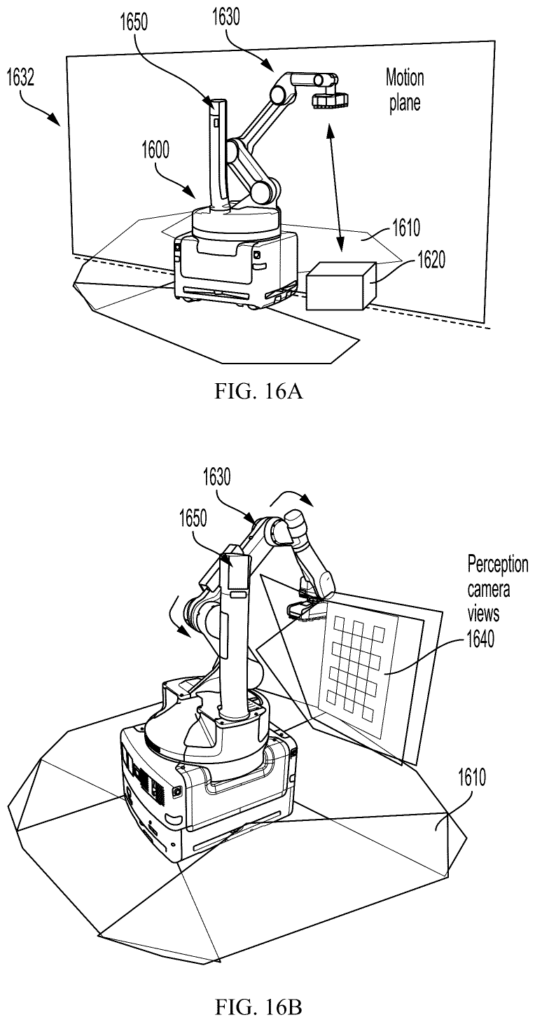

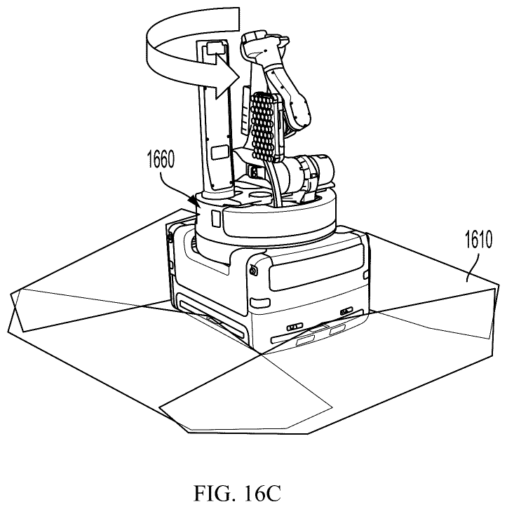

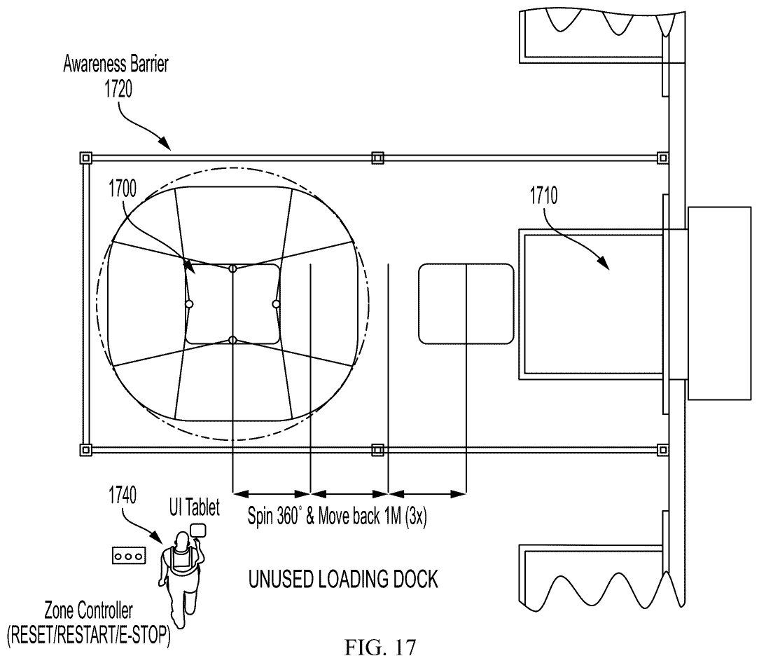

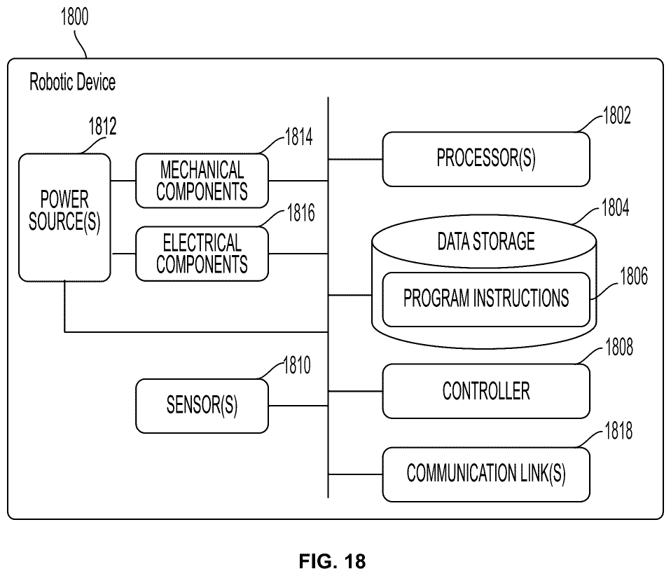

An example of a component of the robot that may benefit from periodic alignment and/or calibration include the LIDAR units used for distance sensing on the robot. In some embodiments, alignment/calibration of the LIDAR units may be performed while the robot is operating in a safety mode that permits driving of the robot, but restricts movement of the arm and turntable of the robot. Examples of other safety modes and example operations that may be performed when the robot operations in the other safety modes are described in more detail below in connection with FIGS. 16 and 17.

The LIDAR units may be aligned and calibrated initially by a manufacturer. Further alignment and calibration may be needed after the mobile robot is deployed in an environment such as a warehouse when one or more LIDAR units are replaced and/or when one or more LIDAR units become misaligned due to, for example, a collision of the robot with a wall or other object in its environment. As discussed above, calibration and alignment of LIDAR units mounted to a mobile robot is typically accomplished using an iterative, manual, and time-consuming process that is performed by skilled personnel who know how to make the proper measurements and corrections, thereby limiting the widespread utility of such techniques in the field when such skilled personnel are not available. Some embodiments of the present disclosure relate to techniques for automating calibration and alignment of co-planar LIDAR units mounted on a mobile robot by using the mobility of the robot in combination with known information about the location of the LIDAR units on the robot and characteristics of a known calibration target. When misalignment of a LIDAR unit is detected using the techniques described herein, alignment instructions that can be followed by an untrained operator are generated to instruct the operator how to adjust the alignment (e.g., pitch and roll) of the misaligned sensor to bring it back into alignment with the other sensors.

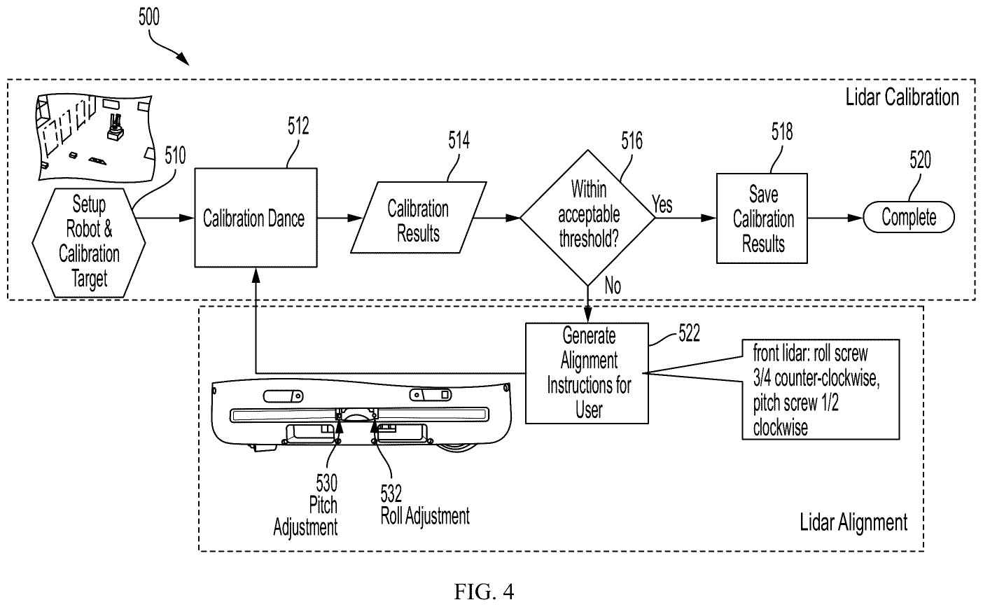

FIG. 4 illustrates a process 500 for automated calibration and alignment of a LIDAR system for a mobile robot in accordance with some embodiments of the present disclosure. In act 510, the mobile robot is arranged a certain distance from a calibration target in a calibration area prior to initiation of the calibration process. Process 500 then proceeds to act 512, where the mobile robot is controlled to perform a “calibration dance,” during which LIDAR measurements of the robot's environment are captured by the LIDAR system of the mobile robot while the robot moves through a particular sequence of movements, examples of which are described in more detail below. The captured LIDAR measurements are then processed to generate calibration data in act 514. The calibration data describes the pose of each of the LIDAR units in the LIDAR system. Process 500 then proceeds to act 516, where it can be determined whether the calibration data for each of the LIDAR units is within an acceptable calibration range (e.g., as specified by one or more thresholds). If it is determined in act 516 that the calibration data is within the acceptable range, process 500 proceeds to act 518, where the calibration data is stored and the calibration process concludes in act 520.

If it is determined in act 516 that one or more of the LIDAR units are misaligned more than an acceptable amount, process 500 proceeds to act 522, where alignment instructions are automatically generated to enable an operator of the robot to realign the LIDAR unit. As shown in FIG. 4, some mobile robots may include LIDAR units mounted to an adjustment mechanism that provides for simple adjustment of roll and pitch of the LIDAR unit by rotating screws to implement the desired adjustment. In the example shown in FIG. 4, the LIDAR unit shown is mounted to an adjustment assembly that includes two screws—a pitch adjustment screw 530 that, when rotated, adjusts the pitch of the LIDAR unit and a roll adjustment screw 532 that, when rotated, adjusts the roll of the LIDAR unit. When used with a mobile robot that includes such an adjustment assembly, the alignment instructions generated in accordance with the techniques described herein may identify the LIDAR unit to be adjusted (e.g., front, rear, left, right) and how to adjust one or both of pitch and roll adjustment mechanisms (e.g., rotate the roll screw ¾ turn counter-clockwise, rotate the pitch screw ½ turn clockwise). Such alignment instructions are straightforward for an untrained operator to implement. Following alignment of the LIDAR unit(s) the alignment can be automatically validated by returning to act 512, where the calibration dance is again performed after alignment. Acts 512-522 can then be repeated as many times as needed to ensure that the LIDAR system of the robot is properly aligned, though it is expected that in most cases only a single alignment need be necessary if the operator precisely follows the generated alignment instructions.

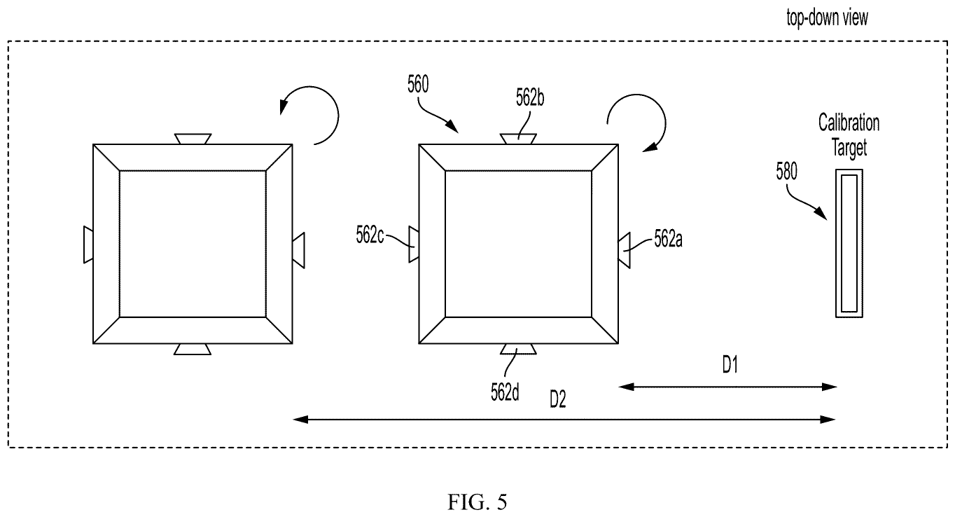

FIG. 5 schematically illustrates a top-down view of an example of a sequence of robot movements (also referred to herein as a “calibration dance”) of a mobile robot 560 arranged relative to a calibration target 580, in accordance with some embodiments. As shown in FIG. 5, the mobile robot 560 includes a LIDAR system having four LIDAR units 562a-562d arranged on different sides of the base of the mobile robot 560. At a first time the mobile robot is located at a first location at a distance D1 from the calibration target. The robot 560 may be controlled to spin at the first location in a first direction (e.g., clockwise as indicated) and a first set of LIDAR measurements may be captured from the LIDAR units 562a-562d as the robot spins at the first location. As described in more detail below, as the robot spins, a series of N LIDAR measurements may be captured and instances where multiple LIDAR units have the calibration target 580 within their field of view may be used to simultaneously estimate roll, pitch, and yaw of each of the LIDAR units.

Following capture of the first set of LIDAR measurements at the first location, the mobile robot 560 may be controlled to move to a second location a distance D2 from the calibration target 580. The inventors have recognized and appreciated that any time delays in the LIDAR units may result in a systematic error in estimating yaw. To counter the possibility of time delays, the robot may be controlled to spin in a first direction (e.g., clockwise) and then spin in a second direction opposite the first direction (e.g., counter-clockwise). Accordingly, during performance of the calibration dance, the robot 560 may be controlled to spin at the second location in a second direction (e.g., counter-clockwise as indicated) different from the first direction. A second set of LIDAR measurements may be captured from the LIDAR units 562a-562d as the robot spins at the second location. As the robot spins at the second location, a series of N LIDAR measurements may be captured and instances where multiple LIDAR units have the calibration target 580 within their field of view may be used to simultaneously estimate roll, pitch, and yaw of each of the LIDAR units.

Although robot 560 is described herein as being located at a first location a distance D1 from the calibration target 580 followed by being located at a second location a distance D2 from the calibration target 580, it should be appreciated that an alternate calibration dance in which the sequence of locations is reversed may also be used. Additionally, although the robot 560 is described herein as first spinning in a clockwise direction and then spinning in a counter-clockwise direction, it should be appreciated that an alternate calibration dance in which the spinning directions are reversed may also be used. Although capturing LIDAR measurements at only two locations is described in connection with the example calibration dance in FIG. 5, it should be appreciated that a calibration dance configured in accordance with the techniques described herein may include capturing LIDAR measurements at more than two locations to improve a signal-to-noise ratio (SNR) by gathering more data points used for the estimation of roll, pitch and yaw. In some embodiments, the components of the calibration dance may be adaptable such that the robot continues to move within a safety field to capture additional LIDAR measurements until sufficient data has been captured to reliably estimate roll, pitch and yaw of each of the LIDAR units.

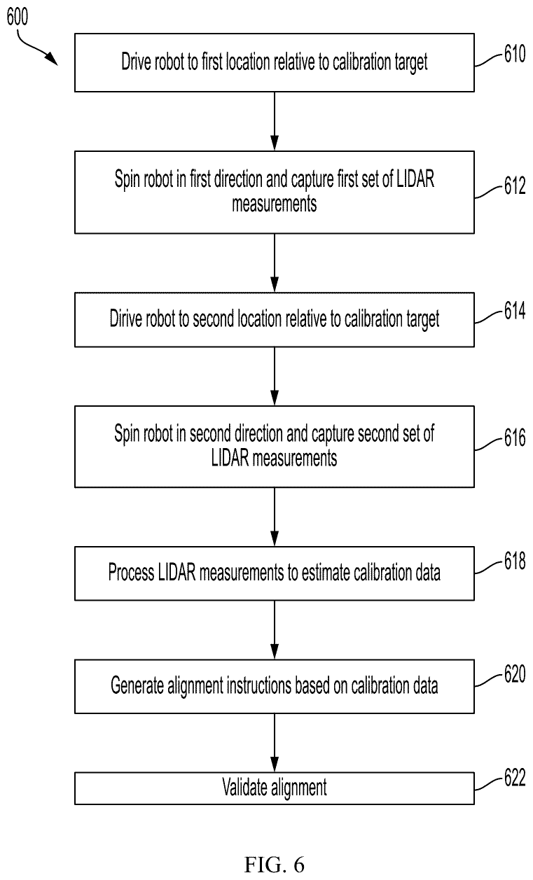

FIG. 6 is a flowchart of a process 600 for using a calibration dance to perform automated calibration and alignment of a LIDAR system for a mobile robot in accordance with some embodiments. Process 600 begins in act 610, where the mobile robot is controlled to drive to a first location relative to a location of a calibration target in the robot's environment. The distance between the first location and the calibration target may be selected according to the dimensions and/or design of the calibration target and/or particular limitations of a safety field within which the calibration dance is performed. The LIDAR signal transmitted from a robot spreads as a cone of LIDAR beams that impinge on the calibration target with the spread of the cone being determined based, at least in part, on the distance between the robot and the calibration target. In general, it may be desirable to set the first location to be at least 0.5-1 meters from the calibration target, but not so far away from the calibration target that few beams from the LIDAR units on the robot fall on the facets of the calibration target due to beam spread, as described above. Process 600 then proceeds to act 612, where the robot is controlled to spin in a first direction (e.g., clockwise) at the first location. As the robot spins, a first set of LIDAR measurements is captured by the LIDAR units mounted on the robot.

Process 600 then proceeds to act 614, where the robot is controlled to drive to a second location. For instance, the robot may be controlled to drive away from or toward the calibration target such that a second distance between the second location and the calibration target is different from the first distance between the first location and the calibration target. Process 600 then proceeds to act 616, where the robot is controlled to spin in a second direction (e.g., counterclockwise) at the second location, the second direction being different from the first direction. As the robot spins, a second set of LIDAR measurements is captured by the LIDAR units mounted on the robot.

Process 600 then proceeds to act 618, where the plurality of LIDAR measurements including the first set of LIDAR measurements and the second set of LIDAR measurements are processed to estimate calibration data (e.g., a pose of each of the LIDAR units). Processing LIDAR measurements to estimate calibration data in accordance with some embodiments is described in more detail below. Process 600 then proceeds to act 620, where alignment instructions are generated based, at least in part, on the calibration data estimated in act 618. For instance, if one or more of the LIDAR units is determined to be misaligned by more than a threshold amount, alignment instructions may be generated that instruct an operator of the robot how to adjust the alignment of the LIDAR unit to correct the misalignment. In some embodiments, generating the alignment instructions includes providing the instructions on a user interface associated with the robot (e.g., on a display of a computing device in communication with the robot). In some embodiments, the alignment instructions may be provided, at least in part, on the robot itself. For instance one or more lighting modules mounted on the robot may be controlled to provide, at least in part, information associated with the alignment instructions, such as indicating which LIDAR unit(s) are misaligned.

Process 600 then proceeds to act 622, where the alignment of the LIDAR system is validated following adjustment of the alignment of one or more of the LIDAR units in accordance with the generated alignment instructions. For instance, validating alignment of the LIDAR system may be performed by repeating the sequence of acts 610-618 until it is determined that the alignment of the LIDAR units is within an acceptable range or the misalignment error is below a particular threshold value, such that further alignment is not required. In some embodiments, calibration data collected during validation may indicate a small amount of misalignment with a LIDAR unit that is not large enough to require adjustment. In such instances, the calibration data for the LIDAR unit may be stored and used to compensate for the misalignment as the robot processes LIDAR data from that LIDAR unit when in operation. For example, slight pitch/roll offsets that were measured during validation can be accounted for when rendering LIDAR measurement data for use with a visualization tool. As another example, when the robot is used to map an environment, the calibration data collected during validation may be used to compensate for slight misalignments of the LIDAR units, thereby producing more a more accurate map. It should be appreciated that other uses for the calibration data collected during validation are also possible.

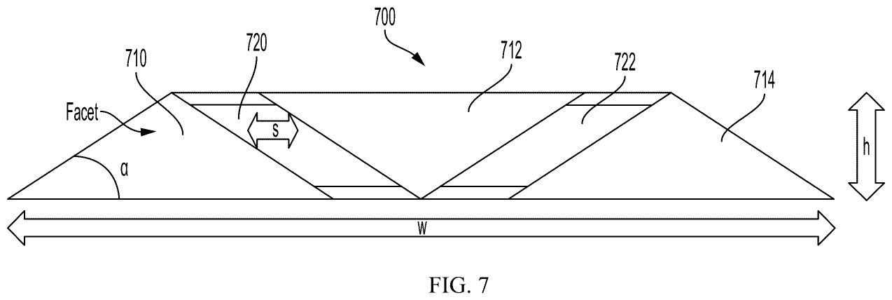

FIG. 7 illustrates an example of calibration target 700 that may be used to automatically calibrate and align a LIDAR system of a mobile robot in accordance with some embodiments of the present disclosure. Calibration target 700 may include a plurality of facets (e.g., facets 710, 712, 714) arranged such that a scanning LIDAR signal intersects two edges of each of the facets. The facets may be separated by spaces 720, 722, which may be formed of a different material than the facets or may be cutouts from the calibration target such that LIDAR signals transmitted by the LIDAR system of the mobile robot pass through the spaces and may be reflected by one or more objects behind the calibration target (i.e., on the opposite side of the calibration target 700 compared to the robot). In some embodiments, the distance s between the facets (i.e., the width of the spaces 720, 722) may be determined based on a point spacing of the transmitted LIDAR signal from the LIDAR units of the robot. For instance, s may be selected such that enough (e.g., 5, 10, 20, etc.) LIDAR points from the transmitted LIDAR signal fall within the space 720 to be able to accurately resolve the right edge of facet 710 and the left edge of facet 712.

As shown in FIG. 7, each of the facets of the calibration target 700 may be implemented as a triangle (e.g., an isosceles triangle) having an angle a. In some embodiments, the angle a may be determined based on the point spacing of the transmitted LIDAR signal from the LIDAR units of the robot and the height h of the calibration target. In some embodiments, the height h of the calibration target may be determined based on the highest pitch angle expected to be observed from misaligned LIDAR units of the robot. In some embodiments, the height h of the calibration target is approximately twice the height of the distance from the floor that the LIDAR units are mounted on the mobile robot (e.g., 30 cm). As shown in FIG. 7, the facets of the calibration target 700 may have alternating orientations. For instance, facet 710 is a “top up” triangle, facet 712 is a “top down” triangle, and facet 714 is a top-up triangle. The width w of the calibration target 700 may be derived from the values of h, s, and a. Alternatively, the height h of the target may be derived from the parameters w, s, and a when the calibration target 700 has a desired width w (e.g., 1 meter). Although three equal sized facets are shown in the example calibration target 700 of FIG. 7, it should be appreciated that fewer than three facets (e.g., two facets) or more than three facets (e.g., four facets, five facets or more) may alternatively be used. Although shown as triangles having straight edges, it should be appreciated that in some embodiments, the facets of the calibration target may have edges that are not a single straight line. For instance, one or more of the facets may have an edge with angled segments having different slopes to enable different types of calibration measurements. Additionally or alternatively, one or more of the facets may have a curved edge.

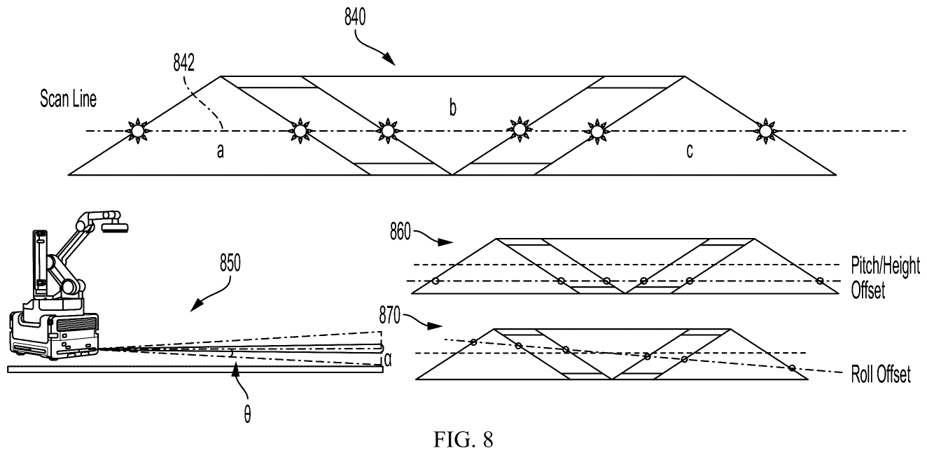

FIG. 8 illustrates an example of a LIDAR scan line impinging on a calibration target as the robot spins at a particular location. As shown in example 840 of FIG. 8, when the LIDAR units are aligned, the LIDAR scan line intersects the facets of the calibration target along a straight line at an expected height along the calibration target. Schematic 850 of FIG. 8 shows that the LIDAR signal transmitted from a robot spreads as a cone of LIDAR beams that impinge on the calibration target with the spread of the cone being determined based, at least in part, on the distance between the robot and the calibration target. Example 860 of FIG. 8 shows that when there is pitch/height offset of one or more of the LIDAR units, the LIDAR scan line, though straight across the calibration target, is displaced vertically relative to an expected height of the scan line. Example 870 of FIG. 8 shows that when there is a roll offset of one or more of the LIDAR units, the LIDAR scan line is not straight across the calibration target even though the center of the LIDAR scan line may be at the expected vertical height on the calibration target. Misalignments of the LIDAR units in both pitch/height and roll may result in LIDAR scan lines that are both angled and vertically displaced relative to the expected position of the scan line on the calibration target. As described in further detail below, the orientation of the LIDAR scan line relative to an expected location of the LIDAR scan line when the LIDAR units are properly aligned may be determined based on the position where the LIDAR measurements intersect the edges of each of the facets.

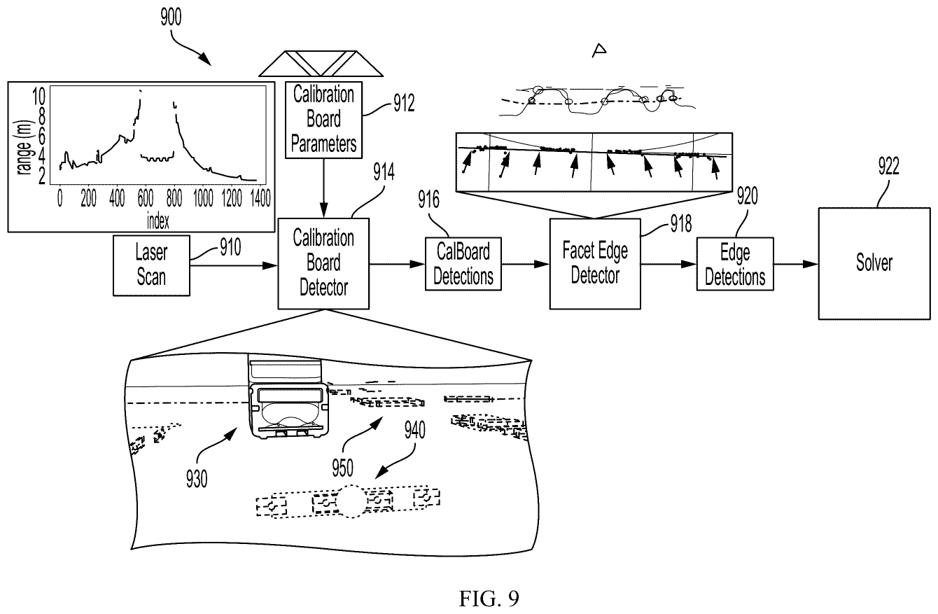

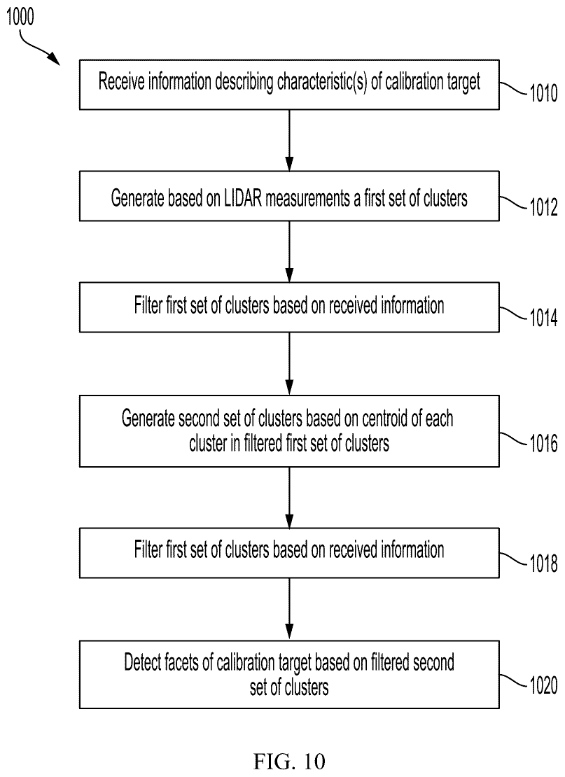

FIG. 9 illustrates a process 900 for estimating calibration data using a calibration target in accordance with some embodiments of the present disclosure. Process 900 begins in act 910 where a laser scan is performed to obtain a plurality of LIDAR measurements. For instance, as described above, as the robot spins at a particular location in its environment, LIDAR signals are transmitted from the LIDAR units mounted on the robot and signals reflected by objects in the environment are detected. Process 900 then proceeds to act 914, where the location of the calibration target in the environment is detected using, at least in part, calibration target parameters 912 describing characteristics of the calibration target (also referred to herein as a “calibration board”). For instance, the calibration target parameters 912 may specify one or more of the parameters a, s, h, and w described above in connection with the example calibration target of FIG. 7. As illustrated in FIG. 9, the robot 930 operating within an environment may detect the presence of a calibration target 940 in addition to other objects 950 in the robot's environment based on detected reflections of the LIDAR signals from objects in the environment. Some embodiments use information about the calibration target to determine the location of the calibration target from among all objects detected in the robot's environment. An example process for detecting a calibration target in the environment of a robot is described in more detail with regard to FIG. 10.

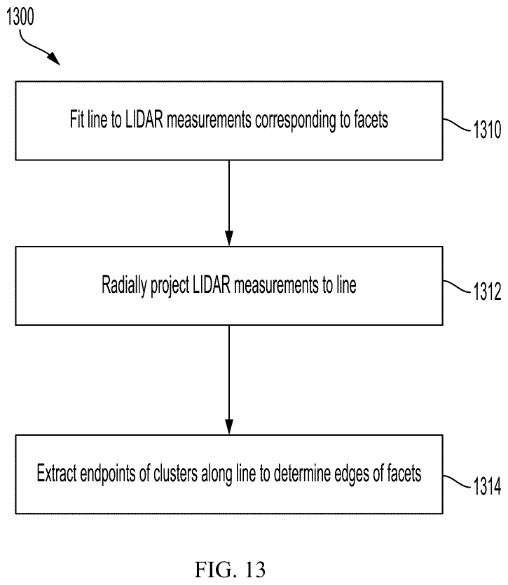

The output of the calibration target detection process 914 is information specifying the calibration target detections 916. As described herein, an estimation of the alignment of the LIDAR units using the techniques described herein may be based on accurately detecting the edges of the facets of the calibration target to be able to determine the location of the LIDAR scan line intersecting those edges. Accordingly, process 900 then proceeds to act 918, where the information specifying the calibration target detections 916 is provided as input to a process for detecting facet edges on the calibration target using the plurality of LIDAR measurements obtained during the calibration dance. An example process for detecting the edges of facets is described in connection with FIG. 13. The output of the facet edge detection process 918 is a set of edge detections 920. Process 900 then proceeds to act 922, where the edge detections 920 are provided as input to a solver to determine calibration data for the LIDAR units mounted to the mobile robot. In some embodiments, the solver process 922 may be configured to perform a non-linear optimization process to estimate the calibration data for the LIDAR units.

FIG. 10 illustrates a multi-scale clustering and filtering process 1000 for automatically detecting a calibration target in an environment of a mobile robot in accordance with some embodiments of the present disclosure. Process 1000 begins in act 1010, where information describing one or more characteristics of the calibration target is received. For instance, one or more of the parameters a, s, w, and h described in connection with the example calibration target of FIG. 7 may be received in act 1010. Process 1000 then proceeds to act 1012, where a first set of clusters is generated based on a plurality of LIDAR measurements captured as the robot spins in a fixed location during a LIDAR scan. In some embodiments, the first set of clusters may be generated using Euclidean clustering at a fine scale. This first round of fine-scale clustering may identify LIDAR return signals that may originate from a calibration target facet, which may be considered as facet candidates. Process 1000 then proceeds to act 1014, where the clusters in the first set of clusters are filtered by identifying invalid clusters that are unlikely to be a calibration target facet. For instance, using the received information about the characteristics of the calibration target, clusters that are too far, have the wrong shape, or have some other characteristic that indicates the cluster is not likely a calibration target facet, are identified as invalid clusters and are removed from the first set of clusters, resulting in a filtered first set of clusters.

Process 1000 then proceeds to act 1016, where a centroid of each of the remaining clusters in the first set of clusters is identified, and a second set of clusters is generated based on the identified centroid of each cluster in the filtered first set of clusters. These identified centroids may represent the positions of facet candidates that are deemed valid. In some embodiments, the clustering performed in act 1016 to generate the second set of clusters is coarser than the clustering performed in act 1012 to generate the first set of clusters. Process 1000 then proceeds to act 1018, where the second set of clusters is filtered to remove invalid clusters using one or more criteria. In some embodiments, the filtering in act 1018 may be based, at least in part, on the received information describing characteristics of the calibration target. For instance, clusters that are non-linear, have the wrong number of facets, or have a separation between facets that does not align with the calibration target information may be identified as invalid clusters and may be removed from the second set of clusters. In some embodiments, the clusters in the second set of clusters may also be filtered using an expected prior calibration target position. For instance, some mobile robots may be configured to accurately estimate their motion as they move (e.g., using kinematic odometry), and information about the motion of the robot relative to an expected position of a calibration target may be used, at least in part, to generate the filtered second set of clusters. Process 1000 then proceeds to act 1020, where the calibration target is identified in the environment based, at least in part, on the filtered second set of clusters.

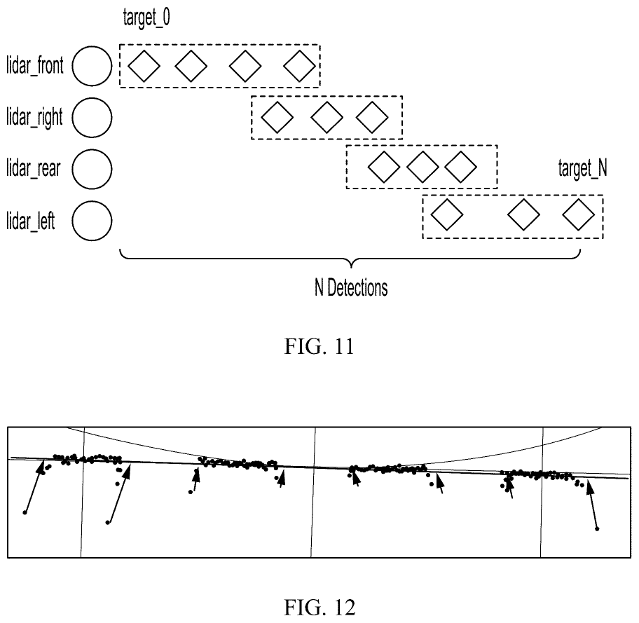

FIG. 11 schematically illustrates a sequence of N (e.g., hundreds) detections of a calibration target by four LIDAR units arranged on different sides (front, right, rear, left) of a rectangular base of a mobile robot as the robot spins in a particular direction in accordance with some embodiments of the present disclosure. As shown in FIG. 11, as the robot spins, there are times at which only a single LIDAR unit detects the calibration target and there are other times when multiple LIDAR units detect the calibration target at the same time. The inventors have recognized and appreciated that it may be possible to estimate roll and pitch using detections of the calibration target from a single LIDAR unit, but that to also determine yaw, simultaneous detections of the calibration target from multiple planar LIDAR units may be used. Accordingly, in some embodiments, multi-LIDAR detections are used to simultaneously estimate roll, pitch and yaw of each of the LIDAR units mounted to the mobile robot.

FIG. 12 schematically illustrates a technique for accurately detecting the edges of facets of a calibration target in accordance with some embodiments of the present disclosure. FIG. 12 illustrates an example of the mixed pixel effect, which occurs when a LIDAR beam falls on an edge where there is a discontinuity in distance between objects on either side of the edge. Because of the discontinuity in distance, the distance measurement appears in the reflected LIDAR signal as an average (e.g., a weighted average) of the distances on either side of the edge. In the case of a calibration target described herein, where the spaces between the facets of the calibration target are cut out of the calibration target such that the background is observed through calibration target, such discontinuities at the edges of the facets occur, resulting in a blurring of the edge. The mixed pixel effect is amplified when an object in the background is located close to the calibration target, which results in reflections from both the background and the facet on the calibration target having similar intensities. Some embodiments use a heuristic to correct for the mixed pixel effect. In such embodiments, an example of which is shown in FIG. 12, a line is fit to points with some outlier rejection (e.g., the line is not fit to points more than a threshold distance away from the clusters of points). For each of the facets of the calibration target, points located within a certain distance of the line (so called “mixed pixels” or “mixels”) are angularly projected back onto the line. In some embodiments, Euclidean clustering may be used to determine which mixels are close enough to be projected back to the line and which should be ignored. Separate facet detections may be used to associate certain mixels with certain facets for the projection process.

FIG. 13 illustrates a process 1300 for accurately extracting edges of facets from LIDAR measurements at least partially accounting for the mixed pixel effect, in accordance with some embodiments of the present disclosure. In act 1310, a line is fit to LIDAR measurements corresponding to facets of the calibration target. For instance, as shown in FIG. 12, a line may be fit to clusters of points that clearly correspond to facets of the calibration target (i.e., points that are not mixed pixels). Process 1300 may then proceed to act 1312, where at least some of the points corresponding to LIDAR measurements near the line (e.g., within a threshold distance to the line) are radially projected back to the line to account for the mixed pixel effect. After radially projecting nearby points back to the line, all of the points fall on the line and the resulting clusters represent a facet on the calibration target. Process 1300 may then proceed to act 1314, where the endpoints of the clusters along the line may be extracted to determine the position of the edges of the facets. The edges of the facets may then be used to estimate the current pose of the LIDAR units mounted on the robot as described herein.

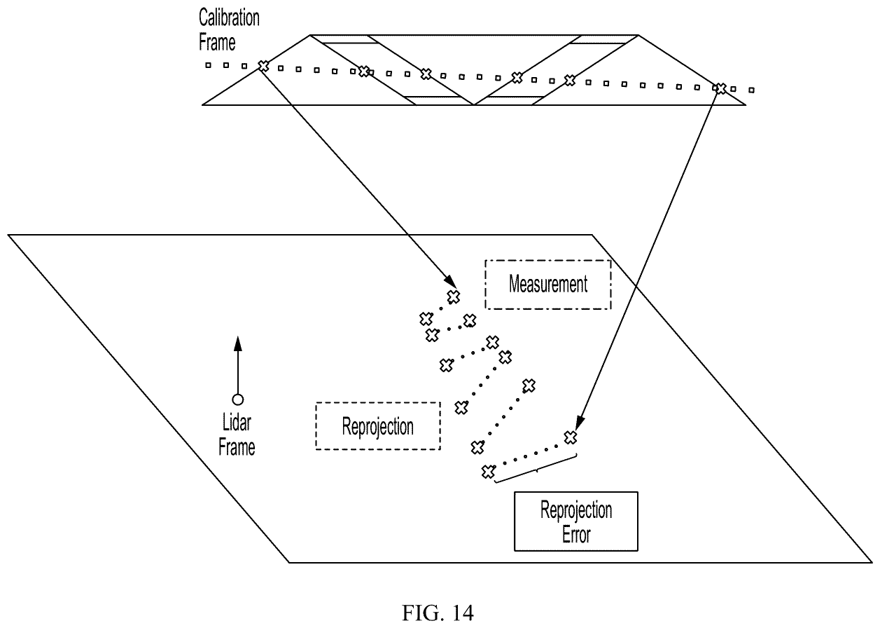

FIG. 14 schematically illustrates a process of estimating the pose (roll, pitch, yaw) of each LIDAR unit in a robot (LIDAR) frame by sampling cross sections of a static, known calibration target from multiple viewpoints (i.e., from multiple LIDAR units on the robot) in accordance with some embodiments of the present disclosure. Such a process jointly solves for the LIDAR unit pose and robot base trajectory, and may leverage nonlinear solvers that support automatic differentiation. As shown in FIG. 14, the features of interest are the positions of the edges of the facets of the calibration target, as measured in the LIDAR plane. In the example calibration target described herein with regard to FIG. 7, there are six edges of the three facets, so six features may be used in the optimization. For each LIDAR, its nominal position in the LIDAR frame on the robot is known and a position of where the six features are expected to be observed in the calibration frame can be reprojected from the calibration frame to the LIDAR frame as shown in FIG. 14. For each of the features, the Euclidean distance between the actual measurement and the reprojection of the expected location of the feature in the LIDAR frame is a reprojection error for that feature. The sum of the Euclidean differences for the six features may be provided as input to a non-linear optimization to drive the pose estimate for the LIDAR unit to a correct position. Stated differently, the pose of each LIDAR unit that minimizes the sum of Euclidean reprojection errors is computed in some embodiments using a constrained non-linear least-squares solver. For the constraints, the non-linear optimization may assume that, relative to the calibration target, the robot base is fixed in Z, roll and pitch and is free in X, Y, and yaw. The non-linear optimization may further assume that, relative to the robot base, the LIDAR units are fixed in position (X, Y, Z) but are free to move in orientation (roll, pitch, yaw).

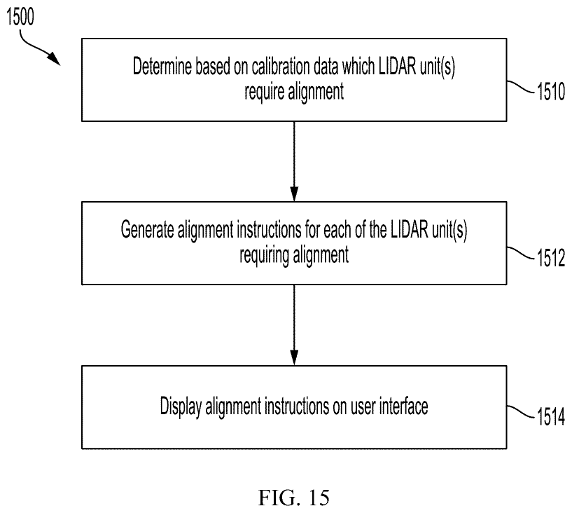

FIG. 15 illustrates a process 1500 for generating alignment instructions based on calibration data generated in accordance with the techniques described herein. Process 1500 begins in act 1510, where based on the calibration data output from the optimization process described in FIG. 14, it is determined which of the one or more LIDAR units require alignment. For instance the calibration data may indicate that the front, rear and left LIDAR units have current poses that are within acceptable ranges for each of roll, pitch and yaw, but that the right LIDAR unit is misaligned. Accordingly, in this example the right LIDAR unit would be identified in act 1510 as the only LIDAR unit requiring alignment. Process 1500 then proceeds to act 1512, where alignment instructions for each of the LIDAR units requiring alignment are generated. Continuing with the example above, based on the calibration data determined for the right LIDAR unit, alignment instructions describing how to adjust the LIDAR unit to bring it back into proper alignment may be generated. As described above in connection with FIG. 4, in some embodiments, each of the LIDAR units is mounted to an alignment mechanism that enables simple adjustment of pitch and roll of the LIDAR unit via two screws that can be rotated clockwise or counterclockwise to make the adjustment. In such embodiments, the alignment instructions generated in act 1512 of process 1500 may translate the calibration data into a set number of partial (e.g., ¼, ½, ¾) or full turns of one or both of the pitch adjustment screw or the roll adjustment screw to enable an untrained operator to make the adjustment. Process 1500 then proceeds to act 1514, where the alignment instructions generated in act 1512 are displayed on a user interface of a computing device associated with the robot. For instance, a user interface may be presented on a controller of the robot in communication with the robot, and the alignment instructions may be displayed on the user interface. In other implementations, the user interface may be presented on a computing device separate from (e.g., a tablet computer, a laptop computer, a smartphone) but in communication with the robot. In some embodiments, only alignment instructions associated with misaligned LIDAR units are displayed on the user interface and information about properly aligned LIDAR units is not shown on the user interface.

In some embodiments, LIDAR unit alignment/calibration may be performed while the mobile robot is in a first safety mode associated with a set of limits that permits operation of the calibration dance routine described herein but restricts operation of some components of the mobile robot that are not needed to perform the LIDAR alignment/calibration. For instance, as discussed above, the calibration dance can be performed by driving and spinning the robot in a programmed sequence of acts while recording sensor data reflected from a calibration target. In such an operation, movement of the turntable and the arm of the mobile robot is not needed. Accordingly, in the first safety mode, operation of the turntable and arm may be disabled/locked to prevent unintended collisions of these components with humans or environmental objects near the robot during performance of the calibration dance, thereby providing for safe operation of the robot. In some embodiments, it is reasonable to assume that clearing a ground area by detecting objects within a radius surrounding the robot (e.g., using the LIDAR system) corresponds to clearing a vertical volume directly above that area.

LIDAR alignment/calibration is provided as one example of an operation that may performed in the first safety mode in which driving is permitted, but rotation of the turntable and movement of the arm of the robot is restricted. However, it should be appreciated that other operations may also be performed in the first safety mode provided that the operations can be performed within the set of limits defined in the first safety mode. For example, it may be beneficial for the mobile robot to check the health of one or more components of the driving system. Such a health check may be performed by engaging the driving system of the robot and monitoring its performance without the need to use the turntable or the arm of the robot. As such, the driving system health check operation may be performed within the first safety mode. Other operations are also possible.

FIGS. 16A and 16B schematically illustrate operations that may be performed when the mobile robot is configured in a second safety mode in accordance with some embodiments of the present disclosure. The mobile robot may be configured to provide self-safeguarding in the second safety mode by using the LIDAR system to detect objects within a radius surrounding the robot and restricting motion (e.g., limiting/disabling motion) of the base and the turntable of the robot, while permitting motion of the robot arm in a vertical (e.g., sagittal) plane. In some embodiments, it is reasonable to assume that clearing a ground area by detecting objects within a radius surrounding the robot corresponds to clearing a vertical volume directly above that area. In some embodiments, speeds of the arm within the vertical plane may be monitored and speed limits enforced within the set of limits defined by the second safety mode. When in the second safety mode, the robot may be configured to perform one or more health check and/or calibration operations that may be accomplished within the movement limits enforced by the second safety mode.

FIG. 16A illustrates performance of a health check operation when a mobile robot 1600 is in the second safety mode. In the second safety mode, the LIDAR system may be used to detect objects in a field of view 1610 surround the mobile robot. The mobile robot 1600 shown in FIG. 16A may be configured to grasp and move boxes or other objects. To ensure that the robot is working properly (e.g., after being serviced), the robot may perform a health check operation in the second safety mode to grasp a box with its vacuum based gripper and move the grasped box through a vertical trajectory. Performing such an operation may facilitate, for example, checking that the vacuum system is working properly, checking that the perception system 1650 is able to capture an image of the box 1620, and checking that the actuators in the joints of the arm 1630 of the robot may be controlled properly to grasp the box 1620 and move the box through a trajectory in the vertical plane 1632. As shown in FIG. 16A, a portion of the field of view 1610 of the LIDAR system may be muted (e.g., ignored) to enable the robot 1600 to use its perception system 1650 to detect the box 1620 without the LIDAR system triggering a shut down procedure due to the presence of box 1620 in field of view 1610. By restricting the motion of the base and turntable of the robot 1600, the health check operation shown in FIG. 16A may be performed safely as the box 1620 is grasped and moved through a vertical trajectory within plane 1632.

FIG. 16B shows an example of a calibration operation that may be performed in the second safety mode in accordance with some embodiments of the present disclosure. Perception system 1650 of the robot may include a plurality of camera modules, as described above. During operation of the mobile robot (and/or after service, such as replacement of a camera module), one or more of the camera modules of perception system may require calibration. For example, when the health check operation shown in FIG. 16A indicates that one or more camera modules of the perception system 1650 are not properly calibrated, the mobile robot may be configured to perform the calibration procedure shown in FIG. 16B. During the calibration procedure shown in FIG. 16B, the robot may be configured to grasp a calibration target 1640 with its gripper and orient the calibration target within the field of view of the camera module(s) of the perception system by moving joints of arm 1630 within the vertical motion plane 1632. In some embodiments, the calibration target 1640 may include a checkerboard pattern or some other suitable pattern that may be sensed by the perception system 1650 to determine a set of calibration parameters associated with the perception system 1650. The set of calibration parameters may be stored (e.g., in a memory of the mobile robot) and used in future operations in which the perception system 1650 is configured to capture images of the environment of the robot (e.g., when detecting boxes for grasping). Because the calibration procedure shown in FIG. 16B does not involve the robot grasping a box, the LIDAR system of the robot may not need to mute any portions of its field of view 1610, thereby providing full coverage surrounding the robot to detect any objects near the robot, further enhancing safety when the calibration procedure is performed.

FIG. 16C illustrates a health check operation that may be performed when the mobile robot is configured in a third safety mode in accordance with some embodiments of the present disclosure. The mobile robot may be configured to provide self-safeguarding in the third safety mode by using the LIDAR system to detect objects within a radius surrounding the robot and restricting motion of the base and the arm of the robot, while permitting rotation of the turntable 1660. In some embodiments, it is reasonable to assume that clearing a ground area by detecting objects within a radius surrounding the robot corresponds to clearing a vertical volume directly above that area. As shown, the arm of the mobile robot may be stowed in the third safety mode such that all portions of the robot are within the footprint of the base of the robot. The health check operation shown in FIG. 16C may be used to check that the turntable 1660 is operating properly. Because of the self-safeguarding limits enforced by the third safety mode, the turntable 1660 may be rotated at different speeds including full power (e.g., max rotation speed) to check that the turntable is operating properly.

Although only three safety modes are described herein, it should be appreciated that any number of safety modes, including a single safety mode or more than three safety modes, may be implemented, and embodiments of the present disclosure are not limited in this respect. In some embodiments, some components of the robot may be configured to always be active (e.g., their motion may not be restricted) in all safety modes. For instance, the inventors have recognized that components, such as the perception mast, which do not extend beyond the footprint of the base of the robot may always be active because they pose a minimal safety risk. Additionally, other components such as the actuators in the wrist of the robot may also always be active, given their relatively low safety risk compared to the actuators in the joints of the arm of the robot.

In some embodiments, the set of limits associated with a safety mode may not be fully predefined prior to operation of the robot. For example, some embodiments may employ dynamic safety modes in which the set of limits describing safe operation of the mobile robot within the safety mode are set based, at least in part, on sensed data (e.g., LIDAR measurements) observed by the safety system of the robot. As an example, the movement speed of one or more components of the robot when performing a calibration and/or health safety check operation when in the safety mode may be scaled based on the sensed data observed by the safety system. In this way, if the robot is located in a large clear space (e.g., no other objects are sensed in a large area surrounding the robot) the one or more calibration and/or health safety check behaviors may be performed at high speed, whereas if the available space surrounding the robot is smaller, the calibration and/or health safety check behavior(s) may still be performed, but at a slower speed than if a larger clear space was available. In some embodiments, the extent of clear space surrounding the robot may be determined based, at least in part, on one or more LIDAR measurements as described herein.

In some embodiments, self-safeguarding for a mobile robot may be implemented using sensed data from on-robot sensors (e.g., LIDAR sensors, onboard cameras, etc.). In other embodiments, self-safeguarding for a mobile robot may be implemented, at least in part, using sensed data from off-robot sensors (e.g., sensors arranged on a different robot, sensors fixed in the environment of the robot) that enable the robot to understand is local operating environment to be able to safely perform one or more calibration and/or health safety check behaviors at its current location, define one or more limits for a safety mode, and/or control the robot to drive to another location with more clear space for performing the behavior(s). In some embodiments, the mobile robot may be configured to recognize a localization artifact, which may be used to understand information about the local environment of the mobile robot and/or whether it is safe to perform one or more calibration and/or health safety check behaviors at the robot's current location using one or more the techniques described herein.

Although one or more of the preprogrammed behaviors for performing health checks and/or calibration operations may occur in any open space of the robot's environment, the inventors have appreciated that certain environments, such as a warehouse, often have particular open spaces with existing physical barriers that may augment the self-safeguarding techniques described herein. FIG. 17 shows a top-view of a mobile robot 1700 operating within a portion of an unused loading dock as an example of an open space that may be used in accordance with some embodiments to perform one or more health check and/or calibration operations for the mobile robot. As shown in FIG. 17, the unused loading dock may include physical barrier features such as a loading dock ramp and an awareness barrier 1720 (e.g. implemented as caution tape or rope, etc.) within which the robot may safely operate to perform one or more of the operations described herein. To provide an additional layer of safety, an operator 1740 may be positioned in the unused loading dock environment and may be able to interact with a controller to shut down operation of the robot, if necessary.

FIG. 18 illustrates an example configuration of a robotic device 1800, according to an illustrative embodiment of the invention. An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device).

In some implementations, the robotic device may include force sensors that measure or estimate the external forces (e.g., the force applied by a limb of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

FIG. 18 illustrates an example configuration of a robotic device (or “robot”) 1800, according to an illustrative embodiment of the invention. The robotic device 1800 represents an example robotic device configured to perform the operations described herein. Additionally, the robotic device 1800 may be configured to operate autonomously, semi-autonomously, and/or using directions provided by user(s), and may exist in various forms, such as a humanoid robot, biped, quadruped, or other mobile robot, among other examples. Furthermore, the robotic device 1800 may also be referred to as a robotic system, mobile robot, or robot, among other designations.

As shown in FIG. 18, the robotic device 1800 includes processor(s) 1802, data storage 1804, program instructions 1806, controller 1808, sensor(s) 1810, power source(s) 1812, mechanical components 1814, and electrical components 1816. The robotic device 1800 is shown for illustration purposes and may include more or fewer components without departing from the scope of the disclosure herein. The various components of robotic device 1800 may be connected in any manner, including via electronic communication means, e.g., wired or wireless connections. Further, in some examples, components of the robotic device 1800 may be positioned on multiple distinct physical entities rather on a single physical entity. Other example illustrations of robotic device 1800 may exist as well.

Processor(s) 1802 may operate as one or more general-purpose processor or special purpose processors (e.g., digital signal processors, application specific integrated circuits, etc.). The processor(s) 1802 can be configured to execute computer-readable program instructions 1806 that are stored in the data storage 1804 and are executable to provide the operations of the robotic device 1800 described herein. For instance, the program instructions 1806 may be executable to provide operations of controller 1808, where the controller 1808 may be configured to cause activation and/or deactivation of the mechanical components 1814 and the electrical components 1816. The processor(s) 1802 may operate and enable the robotic device 1800 to perform various functions, including the functions described herein.

The data storage 1804 may exist as various types of storage media, such as a memory. For example, the data storage 1804 may include or take the form of one or more computer-readable storage media that can be read or accessed by processor(s) 1802. The one or more computer-readable storage media can include volatile and/or non-volatile storage components, such as optical, magnetic, organic or other memory or disc storage, which can be integrated in whole or in part with processor(s) 1802. In some implementations, the data storage 1804 can be implemented using a single physical device (e.g., one optical, magnetic, organic or other memory or disc storage unit), while in other implementations, the data storage 1804 can be implemented using two or more physical devices, which may communicate electronically (e.g., via wired or wireless communication). Further, in addition to the computer-readable program instructions 1806, the data storage 1804 may include additional data such as diagnostic data, among other possibilities.

The robotic device 1800 may include at least one controller 1808, which may interface with the robotic device 1800. The controller 1808 may serve as a link between portions of the robotic device 1800, such as a link between mechanical components 1814 and/or electrical components 1816. In some instances, the controller 1808 may serve as an interface between the robotic device 1800 and another computing device. Furthermore, the controller 1808 may serve as an interface between the robotic system 1800 and a user(s). The controller 1808 may include various components for communicating with the robotic device 1800, including one or more joysticks or buttons, among other features. The controller 1808 may perform other operations for the robotic device 1800 as well. Other examples of controllers may exist as well.

Additionally, the robotic device 1800 includes one or more sensor(s) 1810 such as force sensors, proximity sensors, motion sensors, load sensors, position sensors, touch sensors, depth sensors, ultrasonic range sensors, and/or infrared sensors, among other possibilities. The sensor(s) 1810 may provide sensor data to the processor(s) 1802 to allow for appropriate interaction of the robotic system 1800 with the environment as well as monitoring of operation of the systems of the robotic device 1800. The sensor data may be used in evaluation of various factors for activation and deactivation of mechanical components 1814 and electrical components 1816 by controller 1808 and/or a computing system of the robotic device 1800.

The sensor(s) 1810 may provide information indicative of the environment of the robotic device for the controller 1808 and/or computing system to use to determine operations for the robotic device 1800. For example, the sensor(s) 1810 may capture data corresponding to the terrain of the environment or location of nearby objects, which may assist with environment recognition and navigation, etc. In an example configuration, the robotic device 1800 may include a sensor system that may include a camera, RADAR, LIDAR, time-of-flight camera, global positioning system (GPS) transceiver, and/or other sensors for capturing information of the environment of the robotic device 1800. The sensor(s) 1810 may monitor the environment in real-time and detect obstacles, elements of the terrain, weather conditions, temperature, and/or other parameters of the environment for the robotic device 1800.

Further, the robotic device 1800 may include other sensor(s) 1810 configured to receive information indicative of the state of the robotic device 1800, including sensor(s) 1810 that may monitor the state of the various components of the robotic device 1800. The sensor(s) 1810 may measure activity of systems of the robotic device 1800 and receive information based on the operation of the various features of the robotic device 1800, such the operation of extendable legs, arms, or other mechanical and/or electrical features of the robotic device 1800. The sensor data provided by the sensors may enable the computing system of the robotic device 1800 to determine errors in operation as well as monitor overall functioning of components of the robotic device 1800.

For example, the computing system may use sensor data to determine the stability of the robotic device 1800 during operations as well as measurements related to power levels, communication activities, components that require repair, among other information. As an example configuration, the robotic device 1800 may include gyroscope(s), accelerometer(s), and/or other possible sensors to provide sensor data relating to the state of operation of the robotic device. Further, sensor(s) 1810 may also monitor the current state of a function that the robotic system 1800 may currently be operating. Additionally, the sensor(s) 1810 may measure a distance between a given robotic limb of a robotic device and a center of mass of the robotic device. Other example uses for the sensor(s) 1810 may exist as well.

Additionally, the robotic device 1800 may also include one or more power source(s) 1812 configured to supply power to various components of the robotic device 1800. Among possible power systems, the robotic device 1800 may include a hydraulic system, electrical system, batteries, and/or other types of power systems. As an example illustration, the robotic device 1800 may include one or more batteries configured to provide power to components via a wired and/or wireless connection. Within examples, components of the mechanical components 1814 and electrical components 1816 may each connect to a different power source or may be powered by the same power source. Components of the robotic system 1800 may connect to multiple power sources as well.

Within example configurations, any type of power source may be used to power the robotic device 1800, such as a gasoline and/or electric engine. Further, the power source(s) 1812 may charge using various types of charging, such as wired connections to an outside power source, wireless charging, combustion, or other examples. Other configurations may also be possible. Additionally, the robotic device 1800 may include a hydraulic system configured to provide power to the mechanical components 1814 using fluid power. Components of the robotic device 1800 may operate based on hydraulic fluid being transmitted throughout the hydraulic system to various hydraulic motors and hydraulic cylinders, for example. The hydraulic system of the robotic device 1800 may transfer a large amount of power through small tubes, flexible hoses, or other links between components of the robotic device 1800. Other power sources may be included within the robotic device 1800.

Mechanical components 1814 can represent hardware of the robotic system 1800 that may enable the robotic device 1800 to operate and perform physical functions. As a few examples, the robotic device 1800 may include actuator(s), extendable leg(s), arm(s), wheel(s), one or multiple structured bodies for housing the computing system or other components, and/or other mechanical components. The mechanical components 1814 may depend on the design of the robotic device 1800 and may also be based on the functions and/or tasks the robotic device 1800 may be configured to perform. As such, depending on the operation and functions of the robotic device 1800, different mechanical components 1814 may be available for the robotic device 1800 to utilize. In some examples, the robotic device 1800 may be configured to add and/or remove mechanical components 1814, which may involve assistance from a user and/or other robotic device.

The electrical components 1816 may include various components capable of processing, transferring, providing electrical charge or electric signals, for example. Among possible examples, the electrical components 1816 may include electrical wires, circuitry, and/or wireless communication transmitters and receivers to enable operations of the robotic device 1800. The electrical components 1816 may interwork with the mechanical components 1814 to enable the robotic device 1800 to perform various operations. The electrical components 1816 may be configured to provide power from the power source(s) 1812 to the various mechanical components 1814, for example. Further, the robotic device 1800 may include electric motors. Other examples of electrical components 1816 may exist as well.

In some implementations, the robotic device 1800 may also include communication link(s) 1818 configured to send and/or receive information. The communication link(s) 1818 may transmit data indicating the state of the various components of the robotic device 1800. For example, information read in by sensor(s) 1810 may be transmitted via the communication link(s) 1818 to a separate device. Other diagnostic information indicating the integrity or health of the power source(s) 1812, mechanical components 1814, electrical components 1816, processor(s) 1802, data storage 1804, and/or controller 1808 may be transmitted via the communication link(s) 1818 to an external communication device.

In some implementations, the robotic device 1800 may receive information at the communication link(s) 1818 that is processed by the processor(s) 1802. The received information may indicate data that is accessible by the processor(s) 1802 during execution of the program instructions 1806, for example. Further, the received information may change aspects of the controller 1808 that may affect the behavior of the mechanical components 1814 or the electrical components 1816. In some cases, the received information indicates a query requesting a particular piece of information (e.g., the operational state of one or more of the components of the robotic device 1800), and the processor(s) 1802 may subsequently transmit that particular piece of information back out the communication link(s) 1818.

In some cases, the communication link(s) 1818 include a wired connection. The robotic device 1800 may include one or more ports to interface the communication link(s) 1818 to an external device. The communication link(s) 1818 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

What is claimed is:

1. A method of automated calibration for a LIDAR system of a mobile robot, the method comprising:
capturing a plurality of LIDAR measurements including a first set of LIDAR measurements as the mobile robot spins in a first direction at a first location, the first location being a first distance to a calibration target;
processing the plurality of LIDAR measurements to determine calibration data; and
generating alignment instructions for the LIDAR system based, at least in part, on the calibration data.

2. The method of claim 1, further comprising:
detecting, by the LIDAR system, facets of the calibration target in an environment of the mobile robot.

3. The method of claim 2, further comprising:
receiving information describing one or more characteristics of the calibration target,
wherein detecting the facets of the calibration target is based, at least in part, on the received information.

4. The method of claim 3, wherein detecting the facets of the calibration target comprises:
generating, based on information received from the LIDAR system, a first set of clusters;
filtering the first set of clusters based, at least in part, on the received information; and
detecting the facets of the calibration target based, at least in part, on the filtered first set of clusters.

5. The method of claim 4, wherein detecting the facets of the calibration target further comprises:
determining, for each of the clusters in the filtered first set of clusters, a centroid;
generating, using the centroids, a second set of clusters;
filtering the second set of clusters based on one or more filtering criteria; and
detecting the facets of the calibration target based, at least in part, on the filtered second set of clusters.

6. The method of claim 1, wherein
the calibration target includes a plurality of facets, and
processing the plurality of LIDAR measurements comprises detecting positions of edges of each of the plurality of facets of the calibration target.

7. The method of claim 6, wherein detecting positions of edges of each of the plurality of facets of the calibration target comprises:
fitting a line to a plurality of points included in the plurality of LIDAR measurements;
projecting radially to the line, at least some points included in the plurality of LIDAR measurements and not falling on the line; and
detecting positions of the edges of each of the plurality of facets of the calibration target based, at least in part, on the projected points along the line.

8. The method of claim 1, wherein
the mobile robot includes a base,
the LIDAR system includes at least two LIDAR units arranged with overlapping fields-of-view in a same plane on the base of the mobile robot, and
the first set of LIDAR includes LIDAR measurements from each of the at least two LIDAR units,
wherein processing the plurality of LIDAR measurements to determine calibration data comprises using pairs of LIDAR measurements from different LIDAR units to disambiguate one or more of pitch, roll and yaw of the LIDAR units.

9. The method of claim 1, wherein
the LIDAR system includes a plurality of LIDAR units arranged at different locations on the mobile robot, and
generating alignment instructions for the LIDAR system comprises displaying on a user interface:
an indication of which of the plurality of LIDAR units requires adjustment; and
an amount of adjustment required to align a respective LIDAR unit.

10. The method of claim 9, wherein
an alignment of each of the plurality of LIDAR units is configured to be adjusted using a first adjustment mechanism and/or a second adjustment mechanism, and
the amount of adjustment required to align the respective LIDAR unit comprises whether to adjust the first adjustment mechanism and/or the second adjustment mechanism and by how much.

11. The method of claim 10, wherein
each of the first adjustment mechanism and the second adjustment mechanism comprises a screw, and
generating the alignment instructions for the LIDAR system comprises displaying on the user interface, an indication of how much to rotate one or both of the screws.

12. The method of claim 1, further comprising:
determining whether the calibration data is within an acceptable threshold,
wherein generating alignment instructions for the LIDAR system is only performed when it is determined that the calibration data is not within the acceptable threshold.

13. The method of claim 1, further comprising:
receiving an indication that the LIDAR system has been aligned in accordance with the alignment instructions;
capturing by the LIDAR system, a third set of LIDAR measurements; and
validating that the LIDAR system is properly aligned based, at least in part, on the third set of LIDAR measurements.

14. The method of claim 1, wherein processing the plurality of LIDAR measurements to determine calibration data comprises simultaneously estimating roll, pitch and yaw of each of the LIDAR units in the LIDAR system.

15. The method of claim 1, wherein capturing a plurality of LIDAR measurements comprises capturing the plurality of LIDAR measurements using a plurality of direct time-of-flight sensors arranged on a base of the mobile robot in a same plane.

16. The method of claim 1, wherein capturing the plurality of LIDAR measurements further includes capturing a second set of LIDAR measurements as the mobile robot spins in a second direction at a second location, the second location being a second distance to the calibration target, wherein the first direction and the second direction are different and the second distance is different than the first distance.

17. A mobile robot, comprising:
a LIDAR system including a plurality of LIDAR units arranged in a same plane, at least two of the LIDAR units having overlapping fields-of-view; and
at least one hardware processor configured to:
control the mobile robot to capture a plurality of LIDAR measurements by controlling the LIDAR system to capture a first set of LIDAR measurements as the mobile robot spins in a first direction at a first location, the first location being a first distance to a calibration target;
process the plurality of LIDAR measurements to determine calibration data; and
generate alignment instructions for the LIDAR system based, at least in part, on the calibration data.

18. The mobile robot of claim 17, further comprising:
a base, wherein the plurality of LIDAR units are arranged in the base.

19. The mobile robot of claim 18, wherein
the base has four sides,
the LIDAR system includes a LIDAR unit arranged in the same plane on each of the four sides of the base, and
the first set of LIDAR measurements includes LIDAR measurements from each of the LIDAR units in the LIDAR system.

20. A controller for a mobile robot, the controller comprising:
at least one hardware processor configured to:
control the mobile robot to capture a plurality of LIDAR measurements by controlling a LIDAR system arranged on the mobile robot to capture a first set of LIDAR measurements as the mobile robot spins in a first direction at a first location, the first location being a first distance to a calibration target;
process the plurality of LIDAR measurements to determine calibration data; and
generate alignment instructions for the LIDAR system based, at least in part, on the calibration data.
